(19) United States
(12) Patent Application Publication
(10) Pub. No.: US 2026/0261812 A1
(43) Pub. Date: Sep. 3, 2026

(54) MULTI-DIRECTIONAL AUDIO DIFFRACTION MODELING FOR VOXEL-BASED AUDIO SCENE REPRESENTATIONS

(71) Applicant: DOLBY INTERNATIONAL AB, Dublin (IE)

(72) Inventors: Leon TERENTIV, Erlangen (DE); Panji SETIAWAN, Munich (DE); Daniel FISCHER, Fuerth (DE); Christof Joseph FERSCH, Neumarkt (DE); Markus WERNER, Karlsruhe (DE)

(73) Assignee: DOLBY INTERNATIONAL AB, Dublin (IE)

(21) Appl. No.: 19/159,895

(22) PCT Filed: Feb. 23, 2024
(86) PCT No.: PCT/EP2024/054687

§ 371 Date: Aug. 26, 2025

Related U.S. Application Data
(60) Provisional application No. 63/487,176, filed on Feb. 27, 2023.

(30) Foreign Application Priority Data
Feb. 28, 2023 (EP) 23159262.7

(51) Int. Cl. H04S 7/00

(52) U.S. Cl. CPC H04S 7/302; H04S 7/305; H04S 2400/11

(57) ABSTRACT

The disclosure relates to methods of processing audio scene information relating to a voxel-based audio scene represented by a two-dimensional projection map, for rendering audio from an audio source at a source location to a listener at a listener location. One such method includes obtaining first diffraction information relating to an acoustic path between the source location and the listener location, the listener location associated with a first voxel of the projection map; determining first direction information indicative of a first rendering direction based on the first diffraction information; retrieving prestored second diffraction information relating to an acoustic path between the source location and a second voxel of the projection map in a neighborhood of the first voxel; determining second direction information indicative of a second rendering direction based on the second diffraction information; and outputting the first direction information and the second direction information for rendering. The disclosure further relates to corresponding apparatus, computer programs, and com-puter-readable storage media.

### CROSS-REFERENCE TO RELATED APPLICATIONS

This application claims the benefit of priority from U.S. Provisional Application No. 63/487,176, filed on 27 Feb. 2023, and European Patent Application No. 23159262.7, filed on 28 Feb. 2023, each of which is incorporated by reference herein in its entirety.

### TECHNICAL FIELD

The present disclosure relates to techniques of processing audio scene information for audio rendering. In particular, the present disclosure is directed to voxel-based scene representation and audio rendering.

### BACKGROUND

The Moving Picture Experts Group (MPEG) is an alliance of working groups established jointly by the International Organization for Standardisation (ISO) and International Electrotechnical Commission (IEC), that sets standards for media coding, including audio coding. MPEG is organized under ISO/IEC SC 29, and the audio group is presently identified as working group (WG) 6. WG 6 is currently working on a new audio standard (also known as MPEG-I Immersive Audio, ISO/IEC 23090-4).

The new MPEG-I standard enables an acoustic experience from different viewpoints and/or perspectives or listening positions by supporting scenes and various movements around such scenes, such as movements using various degrees of freedom such as three degrees of freedom (3DOF) or six degrees of freedom (6DoF) in Virtual reality (VR), augmented reality (AR), mixed reality (MR) and/or extended reality (XR) applications. A 6 DoF interaction extends a 3 DoF spherical video/audio experience that is limited to head rotations (pitch, yaw, and roll) to include translational movement (forward/back, up/down, and left/right), to allow for navigation within a virtual environment (e.g., physically walking inside a room), in addition to the head rotations.

For audio rendering in VR, AR, MR and XR applications, object-based approaches have been widely employed by representing a complex auditory scene as multiple separate audio objects, each of which is associated with parameters or metadata defining a location/position and trajectory of that object in the scene. Alternatively audio rendering in such environments also uses higher order ambisonics (HOA). However, a new usage of “voxels” for rendering audio scenes is now being explored, such as for use of new immersive audio experiences. Voxels for audio rendering are relevant for media environments implemented in both hardware and software, such as video game and/or VR, AR, MR and XR environments.

A Voxel is a space volume with acoustic properties or audio rendering instructions assigned to it. Voxel size may be an encoder configuration parameter, and it can be (manually or automatically) selected according to a scene geometry level of details (e.g., in the range of 10 cm-1 m).

Voxels for audio rendering can be obtained by:
voxelization (or conversion) of a mesh-based scene representation
from scene representation used for scene generation (or even video rendering) (e.g., by down-sampling of voxels of smaller size)

However, conventional approaches for providing realistic sound for user experiences (including those involving movement) in VR, AR, MR and XR environments using voxels still remain challenging and computationally complex.

Typical techniques for diffraction modeling in three-dimensional audio scenes, such as for computer-mediated reality applications, require re-calculation of diffraction paths and other diffraction information whenever any of the audio scene, the user location L, or the audio source location O change. For example, the diffraction path may change when the user and/or the audio source move through the three-dimensional audio scene. Further, the diffraction path may change when the audio scene itself changes, for example by indicating a door or window that opens or closes, or the like. Frequent re-calculations of diffraction paths may be computationally expensive, which requires comparatively powerful computation devices for implementing computer-mediated reality applications and/or may negatively affect user experience in some cases.

Further, typical techniques for diffraction modeling in three-dimensional audio scenes apply single-path audio diffraction modeling (for the voxel-based audio scene representation) and consider only one diffraction direction along the shortest path from the audio source location O to the listener position L. This may result in the following issues shown in the examples of FIG. 1 and FIG. 2. These figures show a two-dimensional projection map for a voxel-based scene representation (e.g., corresponding to or derived from a voxel-based scene representation). Occluder voxels 110, 210 are indicated by white squares, with the remaining voxels 120, 220 being empty voxels or (air voxels, in general, voxels in which sound can freely propagate). Audio directions 160, 260 towards an un-occluded audio source are indicated by short thin lines, whereas audio diffraction directions 170, 270 towards a virtual sound source determined by diffraction modeling are indicated by short thick lines. If acoustic waves can go around an obstacle from one (or both sides), there are regions 130 close to obstacle corners, or regions 140, 250 behind the obstacle, where the audio diffraction directions may change rapidly (and significantly) from one voxel to the next one.

These large discontinuities in the diffraction azimuth directions may be perceivable when a listener moves from voxel to voxel. It is especially noticeable if the user performs a continuous change of listening positions by natural head or body movements. In this case, perceived discontinuities may negatively influence plausibility and quality of the rendered audio output and may decrease listening user experience.

A special case of the problem at hand is represented by the scenario of a single voxel occluder or obstacle element as shown in the example of FIG. 2. In this case, the single diffracted sound direction 270 goes around the obstacle 210 only from one side. This may produce an unrealistic audio rendering effect since the listener, located behind the occluder 210 or obstacle, expects to perceive the sound coming from both of its sides simultaneously.

There is thus a need for improved techniques for diffraction modeling in two- or three-dimensional audio scenes, particularly two- or three-dimensional audio scenes utilizing voxels. There is a particular need for such techniques that can improve plausibility and quality of the rendered audio output for listeners in a 3DoF/6DoF environment. There is particular need for techniques that do not increase computational burden on devices (e.g., decoders, renderers) implementing these techniques.

### SUMMARY

In view of this need, the present disclosure provides methods of processing audio scene information (in particular, voxel-based audio scene information) for audio rendering, apparatus for processing audio scene information for audio rendering, computer programs, and computer-readable storage media, having the features of the respective independent claims.

One aspect of the present disclosure relates to a method of processing audio scene information relating to a voxel-based audio scene represented by a two-dimensional projection map, for (obtaining information usable for) rendering audio from an audio source at a source location in the audio scene to a listener at a listener location in the audio scene. The method may include obtaining first diffraction information relating to an acoustic path (e.g., diffraction path) within the audio scene between the source location and the listener location. The listener location may be associated with (e.g., correspond to or be included in) a first voxel of the projection map. The method may further include determining first direction information indicative of a first rendering direction (e.g., towards a first virtual sound source, for example embodied by a first azimuth angle) based on the first diffraction information. The method may further include retrieving second diffraction information relating to an acoustic path (diffraction path) within the audio scene between the source location and a second voxel of the projection map. The second diffraction information may be prestored diffraction information. Further, the second voxel may be a voxel in a neighborhood (e.g., predefined neighborhood) of the first voxel. The (predefined) neighborhood may be defined by a neighborhood matrix centered on the first voxel, for example. The method may further include determining second direction information indicative of a second rendering direction (e.g., towards a second virtual sound source, for example embodied by a second azimuth angle) based on the second diffraction information. Retrieving the second diffraction information may not involve applying a pathfinding algorithm. The method may yet further include outputting the first direction information and the second direction information for rendering. It is understood that the first and second rendering directions may be (sufficiently) different from each other.

Configured as above, the proposed method can provide an additional audio rendering direction that is specifically chosen to avoid abrupt changes of diffraction direction when the listener moves from one voxel to the next in the vicinity of an extended occluder. Importantly, this is done with little computational overhead, since the method resorts to prestored diffraction information for neighboring voxels of the listener location voxel (i.e., first voxel).

In some embodiments, the method may further include selecting the second voxel from the neighborhood of the first voxel according to a predefined selection rule.

In some embodiments, the neighborhood of the first voxel may be a predefined neighborhood relative to the first voxel, relating to a predefined set of voxels relative to the first voxel. Then, selecting the second voxel may include successively selecting voxels from the predefined set of voxels in accordance with a predefined selection order. Using a predefined selection order for all listener locations results in a more consistent listener experience.

In some embodiments, selecting the second voxel may further include, for each selected voxel, determining whether prestored diffraction information is available for the selected voxel.

Selecting the second voxel may further include, if prestored diffraction information is available, retrieving the prestored diffraction information and determining a rendering direction based on the retrieved diffraction information for the selected voxel.

In some embodiments, selecting the second voxel may further include comparing the determined rendering direction to the first rendering direction. Selecting the second voxel may further include, if a difference between the determined rendering direction and the first rendering direction is greater than a predefined threshold (angular threshold), taking the selected voxel as the second voxel and taking the determined rendering direction as the second rendering direction.

In some embodiments, the method may further include determining first and second gains respectively associated with the first and second rendering directions based on a spatial relationship between the first and second voxels. The method may further comprise outputting the determined first and second gains for rendering.

In some embodiments, determining the first and second gains may be based on whether the first and second voxels are laterally adjacent or diagonally adjacent in the projection map.

In some embodiments, the first and second gains may be determined based on a predefined Gaussian kernel. The predefined Gaussian kernel may be centered on the first voxel.

In some embodiments, the method may include determining whether the first voxel is adjacent to an isolated occluder voxel of the projection map. The method may further include, if the first voxel is adjacent to the isolated occluder voxel, determining second direction information indicative of a second rendering direction based on the first rendering direction and a spatial relationship between the first voxel and the occluder voxel (e.g., an azimuth angle of a vector pointing from the first voxel towards the occluder voxel).

In some embodiments, obtaining the first diffraction information may involve applying a pathfinding algorithm. Importantly, retrieving the second diffraction information may not involve applying a pathfinding algorithm, but may rely entirely on prestored diffraction information (e.g., in the form of a DLUT database defined elsewhere in the present disclosure).

In some embodiments, the method may further include outputting a representation of the first diffraction information for storage. Accordingly, the first diffraction information may become part of prestored diffraction information for reuse at later stages, for obtaining first diffraction information and/or second diffraction information.

In some embodiments, the diffraction information may include an indication of a corner voxel (diffraction corner) on the acoustic path (diffraction path) for which the diffraction path changes direction and for which the direct line from the first voxel to the corner voxel is not occluded. This may apply to both the first diffraction information and the second diffraction information.

In some embodiments, the diffraction information may further include an indication of a length of the acoustic path.

Another aspect of the present disclosure relates to a method of processing audio scene information relating to a voxel-based audio scene represented by a two-dimensional projection map, for rendering audio from an audio source at a source location in the audio scene to a listener at a listener location in the audio scene. The method may include determining whether a first voxel of the projection map associated with (e.g., corresponding to or including) the listener location is adjacent to an isolated occluder voxel of the projection map. The method may further include, if the first voxel is adjacent to the isolated occluder voxel, obtaining first diffraction information relating to an acoustic path within the audio scene between the source location and the listener location. The method may further include determining first direction information indicative of a first rendering direction based on the first diffraction information. The method may yet further include determining (e.g., calculating) second direction information indicative of a second rendering direction based on the first rendering direction and a spatial relationship between the first voxel and the occluder voxel. Additionally, the method may include a check of determining whether the first voxel is adjacent to a corner voxel indicated by the first diffraction information, before determining the second direction information. This determination may correspond to a check of whether or not acoustic diffraction is actually caused by the occluder voxel.

Configured as above, the proposed method can provide an additional audio rendering direction to thereby improve plausibility of a rendered audio output when the listener is close to a single occluder voxel. Importantly, this is done without significantly increasing computational overhead.

In some embodiments, the second rendering direction may be determined by rotation of the first rendering direction by 90 degrees (i.e., by π/2).

In some embodiments, a direction of rotation (i.e., sense of rotation) for rotating the first rendering direction may be determined based on the first rendering direction and a direction pointing from the first voxel to the occluder voxel.

In some embodiments, the second rendering direction may be determined so that a direction (e.g., azimuth) pointing from the first voxel to the occluder voxel is within a sector (angular sector) spanned by the first and second rendering directions.

In some embodiments, determining whether the first voxel is adjacent to the isolated occluder voxel may include comparing the first voxel to a predefined set of voxels that are indicated as adjacent to an isolated occluder voxel.

Another aspect of the present disclosure relates to a method of processing audio scene information relating to a voxel-based audio scene represented by a two-dimensional projection map, for rendering audio from an audio source at a source location in the audio scene to a listener at a listener location in the audio scene. The method may include determining pathfinding-based diffraction information relating to an acoustic path within the audio scene between the source location and the listener location by applying a pathfinding algorithm. The listener location may be associated with (e.g., correspond to or be included in) a first voxel of the projection map. Further, the pathfinding-based diffraction information may include an indication of a corner voxel (diffraction corner) on the acoustic path (diffraction path) for which the diffraction path changes direction and for which the direct line from the first voxel to the corner voxel is not occluded. The method may further include identifying a set of voxels that are intersected by a portion of the acoustic path extending between the first voxel and the corner voxel. The method may further include determining derived diffraction information for each voxel of the identified set of voxels based on the pathfinding-based diffraction information. The method may yet further include outputting the pathfinding-based diffraction information and the derived diffraction information for storage. The diffraction information may be output to a bitstream, local storage, cloud-based storage, database, file, etc.,

By re-using calculated diffraction information for deriving diffraction information for voxels in the vicinity of the listener voxel, the proposed method can very efficiently populate a database for storing pre-calculated diffraction information, essentially without additional computational burden. Moreover, the proposed method ensures that sufficient prestored diffraction information is available for multi-directional diffraction modeling as described throughout the disclosure, when the listener moves in the vicinity of an occluder or occluding object.

In some embodiments, the derived diffraction information for each voxel of the identified set of voxels may be indicative of the same corner voxel as the pathfinding-based diffraction information.

In some embodiments, the pathfinding-based diffraction information further may include an indication of a length of the acoustic path. Then, determining the derived diffraction information for a given voxel of the identified set of voxels may include determining a derived length of the acoustic path based on the length of the acoustic path and a distance between the first voxel and the given voxel.

According to another aspect, an apparatus for processing audio scene information for audio rendering is provided. The apparatus may include a processor and a memory coupled to the processor and storing instructions for the processor. The processor may be configured to perform all steps of the methods according to preceding aspects and their embodiments.

According to a further aspect, a computer program is described. The computer program may comprise executable instructions for performing the methods or method steps outlined throughout the present disclosure when executed by a computing device (e.g., processor or group of processors).

According to another aspect, a computer-readable storage medium is described. The storage medium may store a computer program adapted for execution on a computing device (e.g., processor or group of processors) and for performing the methods or method steps outlined throughout the present disclosure when carried out on the computing device.

It should be noted that the methods, apparatus, and systems including its preferred embodiments as outlined in the present disclosure may be used stand-alone or in combination with the other methods, apparatus, and systems disclosed in this document. Furthermore, all aspects of the methods and systems outlined in the present disclosure may be arbitrarily combined. In particular, the features of the claims may be combined with one another in an arbitrary manner.

It will be appreciated that apparatus features and method steps may be interchanged in many ways. In particular, the details of the disclosed method(s) can be realized by the corresponding apparatus, and vice versa, as the skilled person will appreciate. Moreover, any of the above statements made with respect to the method(s) (and, e.g., their steps) are understood to likewise apply to the corresponding apparatus (and, e.g., their blocks, stages, units), and vice versa.

### BRIEF DESCRIPTION OF THE DRAWINGS

The invention is explained below in an exemplary manner with reference to the accompanying drawings, wherein

FIG. 1 schematically illustrates an example of a voxel-based audio scene in which large diffraction azimuth changes may occur from one voxel to another for single direction audio diffraction modeling;

FIG. 2 schematically illustrates an example of a voxel-based audio scene in which single direction audio diffraction modeling may result in implausible or unrealistic audio output;

FIG. 3 schematically illustrates an example of multi-directional audio diffraction modeling in the audio scene of FIG. 1, according to embodiments of the disclosure;

FIG. 4 schematically illustrates an example of multi-directional audio diffraction modeling in the audio scene of FIG. 2, according to embodiments of the disclosure;

FIG. 5 schematically illustrates an example of a diffraction path in a voxel-based audio scene, as well as voxels for which a diffraction path may be derived therefrom, according to embodiments of the disclosure;

FIG. 6 is a flowchart illustrating an example of a method of processing audio scene information according to embodiments of the disclosure;

FIG. 7 is a flowchart illustrating another example of a method of processing audio scene information according to embodiments of the disclosure;

FIG. 8 illustrates an example of a neighborhood N (K) of a single occluding voxel K according to embodiments of the disclosure;

FIG. 9A and FIG. 9B illustrate examples of diffraction paths for listener locations in the vicinity of an occluder voxel to which techniques according to embodiments of the disclosure may be applied;

FIG. 10 illustrates an example of a neighborhood N of a listener location voxel L according to embodiments of the disclosure;

FIG. 11A and FIG. 11B illustrate further examples of diffraction paths for listener locations in the vicinity of an occluder voxel to which techniques according to embodiments of the disclosure may be applied;

FIG. 12A to FIG. 12E illustrate examples of Gaussian kernels for gain determination according to embodiments of the disclosure;

FIG. 13A and FIG. 13B are flowcharts illustrating another example of a method of processing audio scene information according to embodiments of the disclosure;

FIG. 14 is a diagram illustrating complexity measures as functions of time for different operating modes/implementations of processing audio scene information for audio rendering according to embodiments of the disclosure;

FIG. 15 schematically illustrates an example of a voxel-based audio scene to which embodiments of the disclosure may be applied;

FIG. 16A to FIG. 16E illustrate examples of multi-directional audio diffraction modeling for different values of an angular threshold h, according to embodiments of the disclosure;

FIG. 17A to FIG. 17C illustrate examples of multipath diffraction directions in different audio scenes when applying multi-directional audio diffraction modeling according to embodiments of the disclosure;

FIG. 18 illustrates an example of multipath diffraction directions in a simple maze test scene when applying multi-directional audio diffraction modeling according to embodiments of the disclosure; and

FIG. 19 schematically illustrates an apparatus for implementing methods according to embodiments of the disclosure.

### DETAILED DESCRIPTION

In the following, example embodiments of the disclosure will be described with reference to the appended figures. Identical elements in the figures may be indicated by identical reference numbers, and repeated description thereof may be omitted.

### Voxel-Based Audio Scene Representations

First, an overview over voxel-related concepts for representation of audio scenes will be given.

What is a voxel for audio rendering?

A voxel is understood as a space volume with acoustic properties or audio rendering instructions assigned to it.

What is a voxel size for audio rendering?

The voxel size may be an encoder configuration parameter. It may be (manually or automatically) selected according to a scene geometry level of details (e.g., in the range of 10 cm-1 m).

How large audio scenes can be handled?

Large audio scenes do not necessarily result in a large number of voxels and high rendering complexity. For example, a large audio scene can be represented as
a set of independent sub-scenes (and method for “teleport” between these representations without a renderer “re-start”)
a set of scenes updates (based on the user position)

How can discontinuity issues caused by voxel granularity be handled?

Any strong discontinuities in sound levels (and jumps of diffracted signal direction) can be avoided by application of interpolation (e.g., in time and space).

How to represent voxel-based audio scenes?

Any voxel-based representation of an audio scene may contain an indication of voxels that are not transmission voxels (e.g., that are occluder voxels), i.e., voxels in which sound cannot propagate or cannot freely propagate-a representation of occluding geometries. This indication may relate to an indication of coordinates (e.g., center coordinates, corner coordinates, etc.) of the respective voxels. The coordinates of these voxels may be represented by grid indices, for example. Additionally, the voxel-based representation may include indications of material properties of the voxels that are not transmission voxels, such as absorption coefficients, reflection coefficients, etc. In addition to the occluder voxels, the voxel-based representation may also indicate transmission voxels (e.g., air voxels), i.e., voxels in which sound can propagate—a representation of sound propagation media. Accordingly, some implementations of voxel-based representations of audio scenes may include, for each voxel in a predefined section of space (e.g., within boundaries enclosing the audio scene), and indication of a respective material property.

For example, a voxel-based audio scene description can be in the form of or part of the voxSceneDiffractionMap( ) syntax element according to the MPEG-I standard as given by Table 1.

TABLE 1
Syntax of voxSceneDiffractionMap( )

| | No. of | |
|---|---|---|
| Syntax | bits | Mnemonic |
| voxSceneDiffractionMap( ) | | |
| { | | |
| numberOfVoxDiffractionMapElements = | | |
| escapedValue(8, 16, 32) | | |
| for (int i = 0; i < | | |
| numberOfVoxDiffractionMapElements; i | | |
| ++) { | | |
| voxDiffractionMapValue[i]; | 1 | bslbf |
| voxDiffractionMapPosPackedS[i]; | NbitsMap | uimsbf |
| voxDiffractionMapPosPackedE[i]; | NbitsMap | uimsbf |
| } | | |
| voxSceneDiffractionPreComputedPathData( ); | | |
| } | | |

Note:
NbitsMap = ceil(log2(voxSceneDimensions[0]*voxSceneDimensions[1] − 1)

Syntax of escapedValue( ) in Table 1 shall be as defined in ISO/IEC 23003-3.

The syntax elements of Table 1 may be defined as follows:

| | |
|---|---|
| numberOfVoxDiffractionMapElements | This element represents the number of block elements |
| | defining the voxel scene diffraction map. |
| voxDiffractionMapValue | This element represents the voxel type ID for the |
| | diffraction map in the voxel block element. |
| voxDiffractionMapPosPackedS | This element represents the packed form of the variable |
| | voxDiffractionMapPosS indicating the voxel indices of |
| | the first (start) voxel defining the diffraction map block |
| | element. |
| voxDiffractionMapPosPackedE | This element represents the packed form of the variable |
| | voxDiffractionMapPosE indicating the voxel indices of |
| | the second (end) voxel defining the diffraction map |
| | block element. |

### Example Processing Chain for Processing Audio Scene Information

In some embodiments, techniques according to the present disclosure may be performed in relation to a processing chain for processing audio scene information for audio rendering. Such processing chain can be used for converting voxel related data into parameters and signals needed for auralization (or audio rendering in general). The processing chain may be implemented in software, hardware, or combinations thereof. For example, the processing chain may be implemented by a renderer/decoder coupled to AR/VR/MR/XR equipment, such as AR/VR/MR/XR goggles. Specific implementations may include game consoles, set-top-boxes, personal computers, etc.

The processing chain receives an audio scene description from a bitstream (or storage/memory). The audio scene description may comprise a representation of a three-dimensional audio scene, including, for example a two-dimensional projection map thereof, and information on a source location of a sound source within the audio scene. The representation of the three-dimensional audio scene may be voxel-based, for example.

The processing chain further receives an indication of a user position (listener location) of a user (listener) within the audio scene. The audio scene description and the user position may be provided to a diffraction direction calculation block (diffraction calculation block) for determining (e.g., calculating) diffraction information. The diffraction information may relate to an acoustic path (acoustic diffraction path) within the audio scene between the source location and the listener location. The diffraction information may then be provided to a diffraction modeling tool for applying diffraction modeling and optionally occlusion modeling, based on the diffraction information. The occlusion modeling may calculate attenuation gains for the direct line between the listener and an audio source. The diffraction modeling tool may output auralized audio data (3DoF auralizer data) that includes, for example, a location of an object to be rendered, an orientation, and/or gains (e.g., frequency dependent gains). The diffraction modeling tool output may be further processed by other rendering stages such as Doppler, Directivity, Distance Attenuation, etc. In general, the diffraction modeling tool may be said to output diffraction information, as detailed below. The auralized audio data may then be used for audio replay, for example.

In summary, a processing chain as described above may be used to convert voxel related data into the parameters for parameters and signals for auralization. The diffraction direction calculation block and the diffraction modeling tool may be seen as non-limiting examples of rendering tools. In general, the rendering tools may generate 3DoF auralizer data.

For such processing chain, methods according to embodiments of the present disclosure may be performed for example in the diffraction direction calculation block (diffraction calculation block) for determining (e.g., calculating) diffraction information. However, the present disclosure shall not be construed to be limited to such processing chains.

### Example Scene Description

The scene description may include a voxel matrix and associated coefficients (e.g., reflection coefficients, occlusion coefficients, absorption coefficients, transmission coefficients etc.). These coefficients may be indicative of a material or material property of the respective voxel. The rendering tools may include, for example, occlusion and diffraction modelling tools. The 3DoF auralizer data may include, for example, object position, orientation and frequency dependent gains.

Further, the voxel-based representation of the three-dimensional audio scene defines psycho-acoustically relevant geometric elements and sound propagation media. In some implementations, the scene description may use the following parameters/interfaces (e.g., the following agreed upon data format, or agreed upon point of data exchange) to provide the information to rendering tools:

Scene size:
in absolute units (e.g., meters)
in number of voxels and/or voxel size

Scene anchors:
in terms of coordinate anchors (to map absolute coordinates to voxel indices)
in terms of scene anchors (to map sub-scene to sub-set of voxels)

Scene content data:
reference to material properties that approximates acoustic effects caused by occluders (sound obstacles) located in the corresponding volume (e.g., coefficients for transmission, reflection, etc.)
reference to sound propagation media properties that approximates an acoustic effect caused by media located in the corresponding volume (e.g., speed of sound, energy absorption, distance attenuation curve, etc.)
rendering control parameter describing intended occlusion modelling effects E.g., “global” or “local” occluder type that determines the length (and shape) of occlusion effect shadow behind this voxel
rendering control parameter describing intended sound diffraction modelling effects E.g., voxel type that controls/causes the change of sound direction (i.e., path of the diffracted sound cannot penetrate this volume)
content control parameters describing audio signal relevance and scene authoring E.g., audio signal IDs and/or signal gains the determines which signal is perceptually relevant (rendered) in the corresponding volume
rendering control parameter describing intended reverberation modelling effects E.g., voxel type that controls reverberation settings (e.g., RT60, DDR, RIR, etc.)

Scene content updates:
referenced to update triggering events

All data can be audio object dependent (to support content creator intent in flexible audio scene authoring).

The 3DoF auralizer data may include the following information:
parameters and associated signals for the set of audio objects (and HOA)
   parameters include the metadata output of the rendering tools (i.e., position, orientation and gains simulating effects of occlusion, diffraction, early reflections, parameters for reverberation coefficients, IR, etc.)
   associated signals represent the audio output of the rendering tools (i.e., downmixed or replicated audio signals)
scene state identifier (i.e., metadata allowing to map the scene description and user input to the 3DoF auralizer data)

### Techniques for Processing Audio Scene Information

Broadly speaking, the present disclosure provides an extension and improvement to existing audio diffraction modeling methods for voxel-based audio scene representations. The extension allows to obtain an additional diffraction sound source to enable a multi-directional audio diffraction modeling method (i.e., the support for multiple audio diffraction paths around an acoustic obstacle). The present disclosure realizes multi-path diffraction modelling by a modification of the existing single-path diffraction modelling framework. This is done in a computationally efficient manner by querying pre-computed diffraction data from the listener position's adjacent/neighboring voxels. This approach avoids execution of additional pathfinding processing steps and requires no extra data in the bitstream payload.

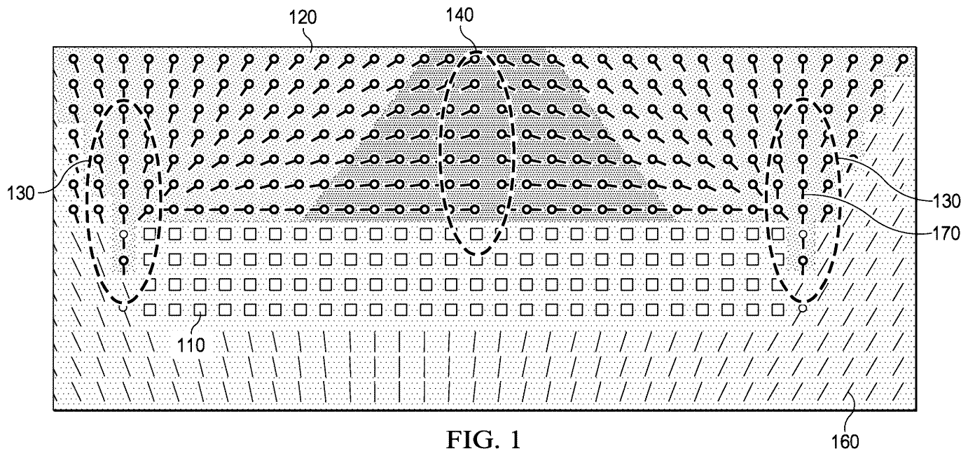

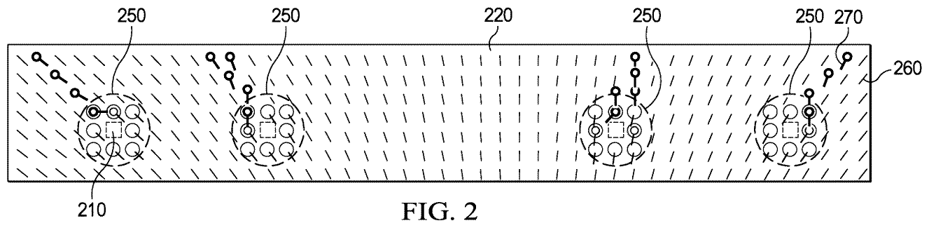

In line with the above, the present disclosure extends audio diffraction modeling with the ability to generate an additional diffraction audio source with a distinct incoming direction. Techniques proposed by the present disclosure only effect the above-described regions 130, 140 as shown in FIG. 1 with discontinuities in diffraction azimuth direction (henceforth referred to as case (A) regions), and regions 250 as shown in FIG. 2 in close proximity to the single voxel occluder or obstacle region (henceforth referred to as case (B) regions).

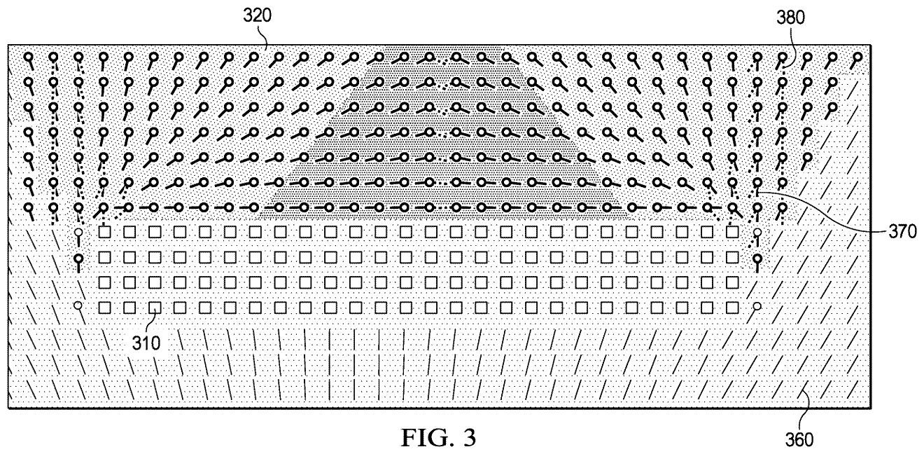

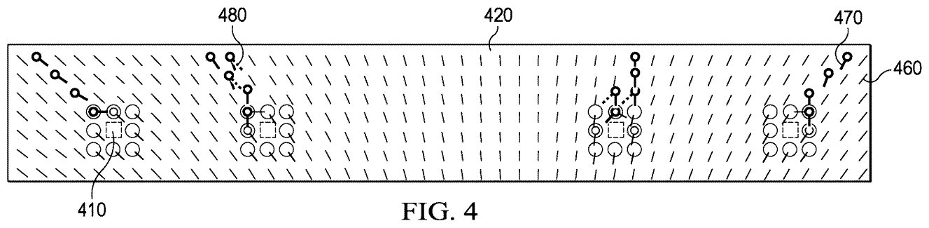

For regions 130, 140 with discontinuities in diffraction azimuth direction (case (A)), techniques according to the present disclosure add, for each affected voxel, an additional sound rendering direction 380 indicated by short dashed lines in the example of FIG. 3. Further, for regions 250 in close proximity to the single voxel occluder or obstacle region (case (B)), techniques according to the present disclosure add, for each affected voxel, an additional sound rendering direction 480 indicated by short dashed lines in the example of FIG. 4.

Multi-directional audio diffraction modeling as proposed by the present disclosure is beneficial for audio rendering quality user experience for the aforementioned regions, i.e., of more than one occluding element (case (A)) and a single occluding element (case (B)). For the remainder of the scene space, the default single-path diffraction mode may still be preferable to keep the audio rendering computational complexity unchanged and low. Accordingly, methods according to embodiments of the present disclosure may include a pre-check for determining whether the listener location is in one of case (A) or case (B) regions. Alternatively, as will be described above, methods according to embodiments of the disclosure may ensure that single-path diffraction modeling is applied to all other cases by appropriate checks within the diffraction modeling loop.

One feasible approach for a multi-path or multi-directional diffraction modelling realization may involve performing an extra pathfinding process. Calculation of an additional audio diffraction source can be based on the results of the first (“primary”) diffraction audio source. However, introducing an additional pathfinding step would significantly increase the computational complexity footprint of the diffraction modelling algorithm. Therefore, the present disclosure proposes alternative methods that do not require additional pathfinding steps.

Specifically, methods according to the present disclosure use pre-computed (or cashed) data stored in the form of, for example, a so-called Diffraction Look Up Table (DLUT). Only one diffraction path per voxel is considered and used to extract all data needed for the proposed multi-path diffraction modelling. The application of DLUT data, or pre-stored data in general, results in a quality boost without considerable computational complexity change, merely at the price of extra local memory usage.

Next, an example of an algorithm for processing audio scene information relating to a voxel-based audio scene will be described. The voxel-based audio scene is assumed to be represented by a two-dimensional projection map, which can be obtained from three-dimensional voxel-based scene information by techniques (e.g., slicing or projection techniques) known to the skilled person. The algorithm is understood to provide information necessary or useful for rendering audio from an audio source at a source location in the audio scene to a listener at a listener location in the audio scene.

According to a main idea of the present disclosure, the proposed algorithm determines “secondary” diffraction audio source data D_{secondary}(L) for listener location L (also referred to as second diffraction information) based on “primary” diffraction audio source data D_{primary}(L) (also referred to as first diffraction information). Depending on whether diffraction information is to be determined for case (A) or case (B), the “secondary” diffraction audio source data D_{secondary}(L) is determined based on the “primary” diffraction audio source data D_{primary}(L) and diffraction audio source data D_{primary}(V) for a neighboring voxel V of the listener location L, as well as a threshold value h (case (A)), or based on the “primary” diffraction audio source data D_{primary}(L), the listener location L, and a location K of an occluder voxel (case (B)).

Thus, the “secondary” diffraction audio source data D_{secondary}(L) is determined based on A) the DLUT data for the “primary” diffraction audio source data D_{primary}(V) for the listener position adjacent or neighboring voxel V:

$${D}_{secondary} ( L ) : {D}_{s econdary} ( {D}_{primary} ( L ) , {D}_{primary} ( V ) , h ) \qquad for case ( A )$$

or
B) the listener location L and single voxel occluding element K positions:

$${D}_{secondary} ( L ) : {D}_{secondary} ( {D}_{primary} ( L ) , L , K ) \qquad for case ( B )$$

Notably, the pre-stored data (e.g., DLUT data) may contain pre-computed (or cached) information about the “primary” diffraction audio source. An implementation example of the contents of DLUT data is given below. The “primary” diffraction audio source data D_{primary} is information that can be retrieved from the prestored data (e.g., DLUT data), if available. In contrast, the “secondary” diffraction audio source data D_{secondary} is not part of the prestored data (e.g., DLUT data), but is calculated during the audio rendering process, based on prestored data.

The following definitions and notation will be used in the remainder of this disclosure:
D_{primary}(L) data for the “primary” diffraction source for the listener voxel L (e.g., first diffraction information)
D_{primary}(V) data for the “primary” diffraction source for the listener neighboring voxel V
D_{secondary}(L) data for the “secondary” diffraction source for the listener voxel L (e.g., second diffraction information)
a_{secondary}(L) azimuth of the “secondary” diffraction audio source (e.g., second rendering direction)
O audio source position
L listener position voxel (or listener position)
C_{L} corner voxel (diffraction corner) for the listener position voxel L
a_{L} azimuth between L and C_{L} (e.g., first rendering direction), for example azimuth angle of a vector pointing from L towards C_{L}
g_{primary} gain for the “primary” diffraction audio source (e.g., first gain)
V listener position neighboring voxel
C_{V} corner voxel (diffraction corner) for the listener position neighboring voxel V E N
a_{V} azimuth between V and C_{V}, for example azimuth angle of a vector pointing from V towards C_{V}
g_{secondary} gain for the “secondary” diffraction audio source (e.g., second gain)
N neighborhood (neighborhood matrix) comprising of all voxels surrounding the listener voxel L
h “primary” and “secondary” diffraction azimuth angle difference threshold
N^{(K)} neighborhood matrix (or neighborhood in general) comprising of all voxels surrounding a single voxel occluding element K
K single voxel occluding element position
a_{K} azimuth between L and K, for example azimuth angle of a vector pointing from L towards K
P projection map
rₚₐₜₕ length of the diffraction path on the projection map

Next, processing steps that are performed by methods according to the present disclosure upon listener position or source position voxel updates will be described. Likewise, these steps may be performed upon an update of the audio scene description. These steps, viz., Step 1 through Step 8 described below, form an algorithm according to the present disclosure. It is understood however that certain embodiments of the disclosure may not require all of the steps and may relate to subsets of Step 1 through Step 8.

### Step 1:

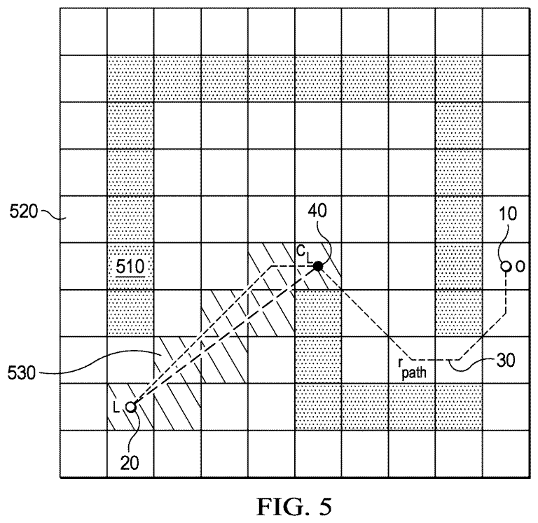

Obtain the “primary” audio diffraction data D_{primary}(L) (first diffraction information), including C_{L} for the listener position voxel L either by
retrieving the “primary” audio diffraction data C_{L} from the prestored data (e.g., DLUT dataset), or
running the pathfinding algorithm (e.g., JPS) and extending the prestored data (e.g., DLUT dataset) for all voxels from the user position L voxel to the corresponding corner voxel C_{L}, as shown in the example of FIG. 5 described below.

The length of the diffraction path r′path may also be obtained for the user position L voxel as part of the diffraction data. It may be used, for example, for calculation of the corresponding gains of the audio diffraction sources.

FIG. 5 shows an example of an acoustic path (acoustic diffraction path) 30 between an audio source at an audio source location O, 10, and a listener at a listener location L, 20, in a voxel-based audio scene represented by a two-dimensional projection map P. The projection map P indicates “air” voxels or empty voxels (i.e., voxels in which sound can propagate, or transmission voxels) 520 and occluder voxels 510 (i.e., voxels in which sound cannot propagate or cannot freely propagate). Accordingly, occluder voxels 510 may be understood to relate to voxels filled with a material other than air, and that can reflect, block, or otherwise alter sound propagation. For the occluder voxels 510, the representation of the voxel-based audio scene may further indicate respective transmission, reflections coefficients and potentially absorption coefficients relating to material properties of these voxels. These coefficients may be linked to ID's or indices of their respective voxels in the voxel-based representation. In general, the voxel based representation may define psycho-acoustically relevant geometric elements and sound propagation media in the audio scene.

As noted above, the (first) diffraction information (“primary” audio diffraction data D_{primary}(L)) includes the location C_{L}, 40, of the corner voxel. It may further include the length of the acoustic path rₚₐₜₕ.

When pre-stored data is not available for the “primary” audio diffraction data D_{primary}(L), the acoustic path (diffraction path) between the source location 10 and the listener location 20 may be determined using a pathfinding algorithm that takes the listener location 20, the source location 10, and the representation of the three-dimensional audio scene (e.g., the two-dimensional projection map or two-dimensional matrix) as inputs. For example, an algorithm for determining the diffraction information may take the listener location 20, the source location 10, and the representation of the three-dimensional audio scene as inputs and outputs a location of the diffraction corner (corner voxel) 40, indicated by CL and optionally the variable rₚₐₜₕ representing the length of the diffraction path. For example, the diffraction information may be determined based on:

$$[ {C}_{L} , {r}_{path} ] = DiffractionDirectionCalculation ( L , O , VoxDataDiffractionMap )$$

where DiffractionDirectionCalculation indicates the algorithm for determining the diffraction information (“pathfinding algorithm”) and VoxDataDiffractionMap indicates the voxel-based representation of the three-dimensional audio scene or a processed version thereof (e.g., 2D projection map or 2D matrix derived therefrom). C_{L} is understood to indicate the coordinates of the diffraction corner (e.g., coordinates, voxel/grid coordinates, or voxel/grid indices of the respective voxel including the diffraction corner).

Here, DiffractionDirectionCalculation may involve any viable pathfinding algorithm, such as the Fast traversal algorithm for ray tracing (cf. Amanatides, J. and A. Woo, A Fast Voxel Traversal Algorithm for Ray Tracing. Proceedings of EuroGraphics, 1987. 87.) and the JPS algorithm (cf. Harabor, D. D. and A. Grastien, Online Graph Pruning for Pathfinding On Grid Maps. Proceedings of the Twenty-Fifth AAAI Conference on Artificial Intelligence, 2011.), for example. Further, one may apply a 2D path search algorithms for this task, using an appropriate 2D projection plane (e.g., projection map) of the 3D voxel-based scene representation.

The pathfinding algorithm is assumed to output a diffraction path that connects the source location 10 to the listener location 20 and that consist of a plurality of straight path segments (line segments) that are sequentially linked end-to-end. Each transition from one path segment to another path segment relates to a change of direction of the diffraction path.

According to the algorithm for determining the diffraction information, the diffraction corner C_{L} may be determined as a voxel that lies on or on the proximity of the diffraction path and is adjacent to a corner voxel (in a set of voxels representing corner voxels on the diffraction map, Cₛₑₜ) of the diffraction map (indicated by the voxel-based representation). For example, the diffraction corner C_{L} may be selected from a set of voxels (Pₛₑₜ) forming the diffraction path as a voxel that is close to a ‘visible’ (from the listener position Lc) corner voxel (belonging to Cₛₑₜ) causing the path (Pₛₑₜ) to change direction. If there are more than one such corners, the one closest to the listener location along the diffraction path (Pₛₑₜ) is selected.

In general, the diffraction path algorithm may be said to determine diffraction information relating to the acoustic diffraction path within the audio scene between the source location and the listener location.

This diffraction information may be sufficient information for the renderer to recover/determine a virtual source location of a virtual audio source that encapsulates effects of acoustic diffraction effects. This is the case for the coordinates of the diffraction corner C_{L} and the diffraction path length rₚₐₜₕ. For example, the virtual source location may be recovered by calculating the direction (e.g., azimuth, or azimuth and elevation) of the diffraction corner when seen from the listener location. Using this direction and taking the path length rₚₐₜₕ of the diffraction path as the virtual source distance to the listener location, the virtual source location can be determined.

It is noted that the diffraction information can be represented in different ways. One option, as noted above, is diffraction information including/storing the path length rₚₐₜₕ and the coordinates (e.g., grid coordinates, etc.) of the diffraction corner (corner voxel) C_{L}.

Returning to FIG. 5, to enhance and accelerate population of the pre-stored data (e.g., DLUT data), the present disclosure proposes to use diffraction information calculated for a given listener location L also for voxels 530 with the same diffraction corner (corner voxel C_{L}), for deriving diffraction information for these voxels.

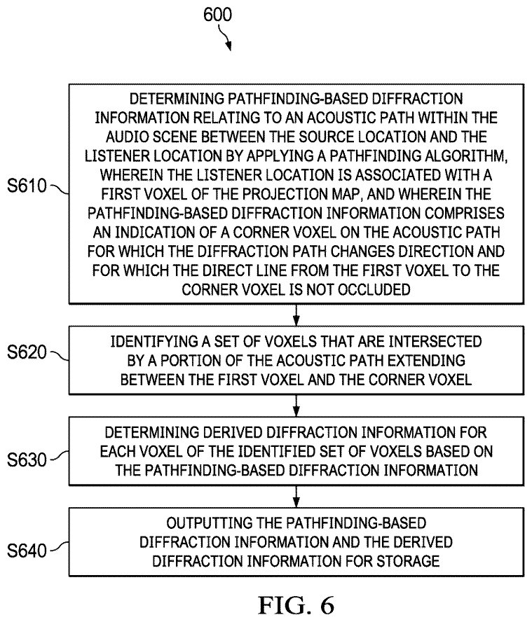

FIG. 6 is a flowchart illustrating an example of a method 600 for enhancing and accelerating population of the pre-stored data (e.g., DLUT data). Generally, method 600 is a method of processing audio scene information relating to a voxel-based audio scene represented by a two-dimensional projection map, for providing information for rendering (e.g., useful for rendering) audio from an audio source at a source location in the audio scene to a listener at a listener location in the audio scene. Method 600 comprises steps S610 through S640 that may be performed whenever diffraction information is not already available for a given listener location (or in general, for a given combination of listener location, source location, and audio scene description (e.g., projection map)).

At step S610, pathfinding-based diffraction information relating to an acoustic path (diffraction path) within the audio scene between the source location and the listener location is determined by applying a pathfinding algorithm. This may be done, for example, in the manner described above. The listener location is associated with (e.g., corresponds to or is included in) a first voxel of the projection map. The determined pathfinding-based diffraction information comprises an indication of a corner voxel (diffraction corner) on (or close to) the acoustic path for which the diffraction path changes direction and for which the direct line from the first voxel to the corner voxel is not occluded (e.g., voxel C_{L} defined above).

At step S620, a set of voxels is identified that are intersected by a portion of the acoustic path extending between the first voxel and the corner voxel. By definition, these are voxels that, when applying the pathfinding algorithm to these voxels, would yield the same corner voxel as the corner voxel determined at step S610 for the first voxel.

At step S630, derived diffraction information is derived for each voxel of the identified set of voxels based on the pathfinding-based diffraction information. As described above, the derived diffraction information for each voxel of the identified set of voxels will be indicative of the same corner voxel as the pathfinding-based diffraction information. However, the length of respective diffraction paths will be different (i.e., shorter).

Thus, if the pathfinding-based diffraction information further comprises an indication of a length of the acoustic path, the length of the acoustic paths for the identified set of voxels needs to be determined (e.g., calculated). Determining the derived diffraction information for a given voxel of the identified set of voxels may accordingly comprise determining a derived length of the acoustic path based on the length of the acoustic path (for the first voxel) and a distance between the first voxel and the given voxel. For example, the distance between the first voxel and the given voxel may be subtracted from the path length determined for the first voxel to determine the derived length of the acoustic path.

Finally, at step S640, the pathfinding-based diffraction information and the derived diffraction information are output for storage, for example as part of the prestored data (e.g., DLUT data). For example, the diffraction information may be output to a bitstream, local storage, cloud-based storage, database, file, etc. Accordingly, the diffraction information determined at steps S620 and S630 can be reused for rendering at later stages.

Next, a further processing step that may be performed by methods according to the present disclosure upon listener position or source position voxel updates will be described.

### Step 2:

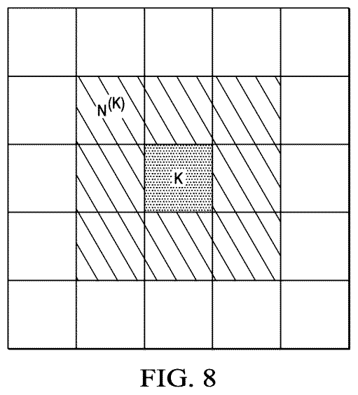

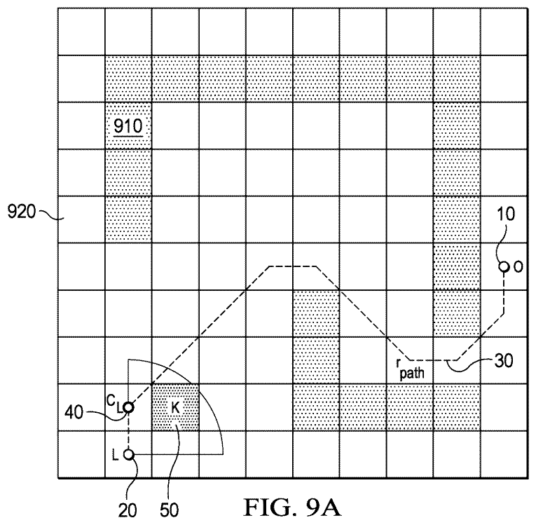

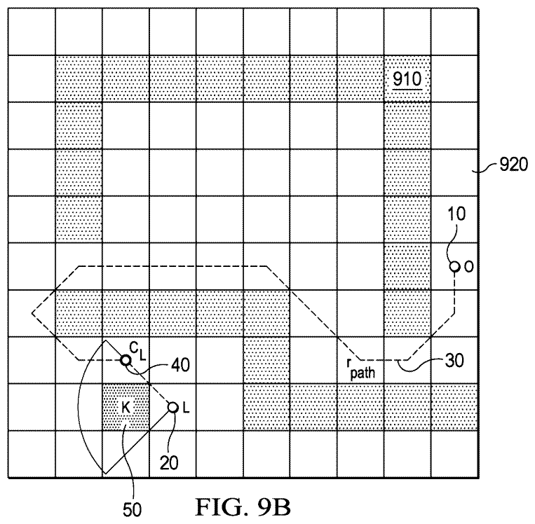

Perform a check whether case (B) applies, see FIG. 4 and FIG. 9A, FIG. 9B. This is true if the following conditions are fulfilled simultaneously:
L∈N^{(K)}: Listener position voxel L belongs to the neighborhood N (K) of the single voxel occluding element K, as shown in FIG. 8
voxels L and C_{L} are adjacent to each other, e.g., |L−C_{L}|<1.5 (in units of voxel size)

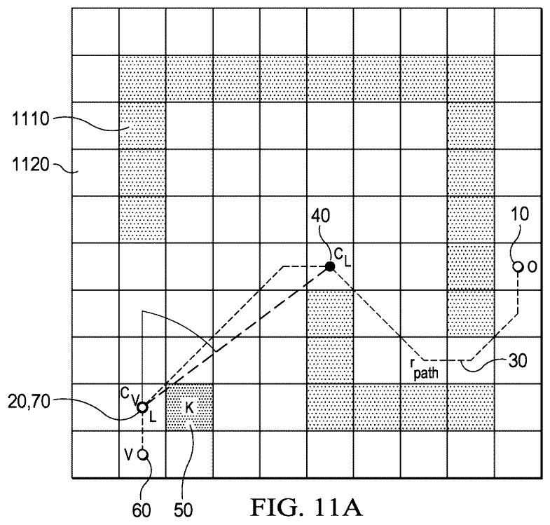

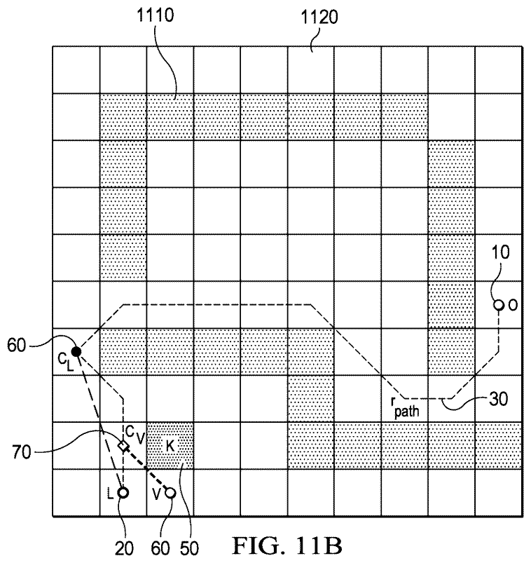

Examples for the second of these conditions are illustrated in FIG. 9A and FIG. 9B. The projection map again indicates occluder voxels 910 and empty voxels 920. A diffraction path 30 with a diffraction corner C_{L}, 40, extends between the source location, O, 10 and the listener location L, 20, which is adjacent to the occluding element K, 50 (isolated occluder voxel). In both FIG. 9A and FIG. 9B, the listener location L voxel is adjacent to the diffraction corner voxel C_{L}, implying that audio diffraction is actually caused by the isolated occluder voxel K, 50, and case (B) applies. Examples of scenarios in which case (B) does not apply are shown in FIG. 11A and FIG. 11B described below. In such case, it may still have to be checked whether case (A) applies, noting that case (A) may also apply when the listener location L is adjacent to the isolated occluding element K, but case (B) does not apply. This is implemented by Step 3 to Step 7 described below.

If the above two conditions are simultaneously fulfilled (i.e., case (B) applies), the “secondary” diffraction audio source information D_{secondary} is determined via the azimuth a_{secondary} as:

$${a}_{secondary} ( L ) = {a}_{L} + sign ( {a}_{L} - {a}_{K} ) π / 2$$

The vector a_{secondary} is determined by the π/2 rotation of the corresponding “primary” diffraction audio source azimuth vector a_{L} (azimuth between L and C_{L}, first rendering direction) around the vector a_{K} (azimuth between L and K) pointing to the single voxel occluding element K position from the listener L position.

Further, the energy gain g_{primary} (first gain) for the “primary” diffraction audio source and g_{secondary} (second gain) for the “secondary” diffraction audio source are calculated as follows:

$${g}_{primary} = 2 / 3 ,$$

$${g}_{secondary} = 1 / 3$$

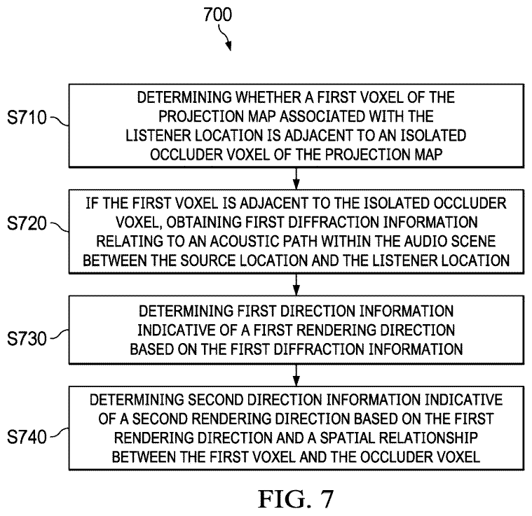

FIG. 7 is a flowchart illustrating an example of a method 700 of processing audio scene information relating to a voxel-based audio scene represented by a two-dimensional projection map, for providing information for rendering (e.g., useful for rendering) audio from an audio source at a source location in the audio scene to a listener at a listener location in the audio scene, in line with the above. Method 700 comprises steps S710 through S740 that may be performed, for example, upon an update of the source location listener location, or audio scene description.

At step S710, it is determined whether a first voxel of the projection map associated with (e.g., corresponding to or including) the listener location is adjacent to an isolated occluder voxel of the projection map. For example, a list of isolated occluder voxels and/or list of voxels adjacent to an isolated occluder voxel may be pre-stored. Thus, determining whether the first voxel is adjacent to the isolated occluder voxel may comprise comparing the first voxel to a predefined set of voxels that are indicated as adjacent to an isolated occluder voxel.

Additionally, this step may include an addition check of determining whether the first voxel is adjacent to a corner voxel indicated by the first diffraction information. If so, it can be concluded that audio diffraction of the audio source at the first voxel is actually caused by the isolated occluder voxel.

Thus, step S710 may correspond to checking the two conditions defined in Step 2 above.

At step S720, if the first voxel is adjacent to the isolated occluder voxel (and optionally, if the additional check at step S710 is satisfied), first diffraction information relating to an acoustic path within the audio scene between the source location and the listener location is obtained.

At step S730, first direction information indicative of a first rendering direction based on the first diffraction information is determined. The first rendering direction may correspond to the “primary” diffraction audio source azimuth vector a_{L} (azimuth between L and C_{L}) defined above.

At step S740, second direction information indicative of a second rendering direction is determined based on the first rendering direction and a spatial relationship between the first voxel and the occluder voxel. The second rendering direction may correspond to the azimuth a_{secondary} defined above. As also described above, in one example the second rendering direction can be determined by rotation of the first rendering direction by 90 degrees. Therein, a direction of rotation (sense of rotation) for rotating the first rendering direction can be determined based on the first rendering direction and a direction pointing from the first voxel L to the occluder voxel K. Specifically, the second rendering direction can be determined via

$${a}_{secondary} ( L ) = {a}_{L} + sign ( {a}_{L} - {a}_{K} ) π / 2$$

In any case, the second rendering direction should be determined such that a direction pointing from the first voxel L to the occluder voxel K (direction defined by azimuth a_{K}) is within a sector spanned by the first and second rendering directions (see FIG. 9A and FIG. 9B, for example).

Next, further processing steps that are performed by methods according to the present disclosure upon listener position or source position voxel updates will be described.

If the determination at Step 2 yields a positive result (i.e., case (B) applies), Step 3 through Step 7 described below are skipped and the algorithm proceeds to Step 8.

If the check at Step 2 however is not fulfilled, then the processing of case (A) applies as described in the following Step 3 through Step 7.

FIG. 11A and FIG. 11B illustrate examples of cases in which Step 2 yields a negative result and case (A) applies (or may apply). The projection map again indicates occluder voxels 1110 and empty voxels 1120. A diffraction path 30 with a diffraction corner C_{L}, 40, extends between the source location, O, 10 and the listener location L, 20, which is in these examples (although not required for case (A) to apply) adjacent to the occluding element K, 50 (isolated occluder voxel). In both FIG. 11A and FIG. 11B, the listener location L voxel is not adjacent to the diffraction corner voxel, implying that case (B) does not apply. In both examples, a neighbor voxel V, 60, to the listener location L voxel is selected, and diffraction information for this neighbor voxel V is obtained from the prestored data (e.g., DLUT database). This (second) diffraction information indicates the diffraction path for the neighbor voxel V, which includes a (second) diffraction corner C_{V}, 70.

### Step 3:

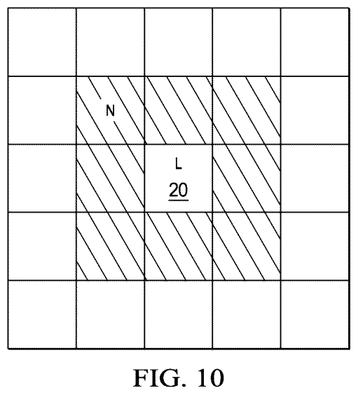

Select a neighboring voxel VE N from the listener position voxel L neighborhood (specified by the neighborhood N (e.g., neighborhood matrix N illustrated in FIG. 10).

If all neighboring voxels have already been processed by the following Step 3 to Step 6 below and resulted in no “secondary” diffraction audio source definition, exit the process without the definition of the “secondary” diffraction audio source.

The order of the neighboring voxel V selection from the neighborhood matrix N may be given by

$$V ( L ) = {V}_{i} ∈ N ( L )$$

For example, the following search order for V={(Lₓ, L_{y+1}), (Lₓ, L_{y-1}), (Lₓ₊₁, L_{y}), (Lₓ₋₁, L_{y}) (Lₓ₊₁, L_{y+1}), (Lₓ₋₁, L_{y+1}), (Lₓ₊₁, L_{y-1}), (Lₓ₋₁, L_{y-1})} can be used:

$$N ( L ) = [ \begin{matrix}{P}_{( x + 1 , y - 1 )} & {P}_{( x + 1 , y + 0 )} & {P}_{( x + 1 , y + 1 )} \\ {P}_{( x + 0 , y - 1 )} & {P}_{( x , y )} & {P}_{( x + 0 , y + 1 )} \\ {P}_{( x - 1 , y - 1 )} & {P}_{( x - 1 , y + 0 )} & {P}_{( x - 1 , y - 1 )}\end{matrix} ] = [ \begin{matrix}{V}_{7} & {V}_{3} & {V}_{5} \\ {V}_{2} & L & {V}_{1} \\ {V}_{8} & {V}_{4} & {V}_{6}\end{matrix} ]$$

According to this search order, the neighbor voxel to the right of L would be selected first, the neighbor voxel to the left of L would be selected second, the voxel above L would be selected third, and so forth.

However, the above is just an example and any search order may be used, as long as it is predetermined and consistently used.

### Step 4:

Check that the prestored data (e.g., DLUT dataset) contains diffraction data for the neighbor voxel V (i.e., the corresponding corner voxel C_{V} and the path length from voxel V to the audio object voxel O).

This may imply simultaneous fulfillment of the following conditions that can be checked before searching the DLUT dataset:
the neighboring voxel V is inside of the projection map P dimensions
the neighboring voxel V is of the sound transmission media type (i.e., air voxel) on the projection map P
the neighboring voxel V is not in the direct (i.e., un-occluded) view-line from the listener to audio source.

In fact, in some implementations these implicit conditions could by checked already before entering diffraction modeling according to Step 2 through Step 7.

If there is no prestored data for the neighbor voxel V (or if the above conditions are not fulfilled), go to Step 3 to select the next voxel.

### Step 5:

Retrieve the corner voxel position C_{V} information from the prestored data (e.g., DLUT dataset) for the neighboring voxel V. The diffraction path length approximation rₚₐₜₕ may also be obtained from the prestored data for calculation of the final gains in the last rendering stage. Based thereon, the angle (azimuth angle, azimuth) a_{V} from V to C_{V} can be determined.

### Step 6:

Check whether the diffraction angle difference is bigger than the threshold value h:

$$\vert {a}_{V} - {a}_{L} \vert \geq h$$

where a_{L} is an angle of L to C_{L} and av is an angle of V to C_{V}.

If the condition is not fulfilled, go to the Step 3 to select the next voxel V.

If the condition is fulfilled, the “secondary” diffraction audio source D_{secondary} is determined via the azimuth a_{secondary} as:

$${a}_{secondary} ( L ) = {a}_{V}$$

### Step 7:

Calculate the energy gain g_{primary} (first gain) for the “primary” diffraction audio source and g_{secondary} (second gain) for the “secondary” diffraction audio source as follows:

$${g}_{secondary} = 1 / 3 ,$$

$${g}_{primary} = 2 / 3 ,$$

$$if \vert L - V \vert == 1 ( in units of voxel size )$$

$${g}_{secondary} = 1 / 5 ,$$

$${g}_{primary} = 4 / 5 ,$$

$$if \vert L - V \vert == 2 ( in units of voxel )$$

Here, |L−V| is the so-called Manhattan metric, but other metrics, with corresponding adaptations, could be used as well.

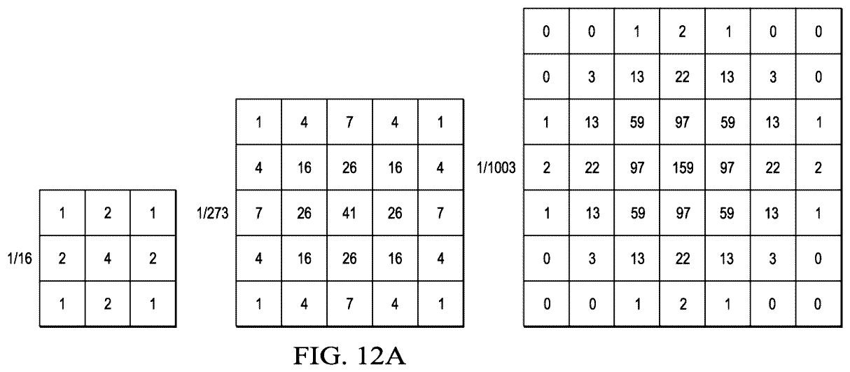

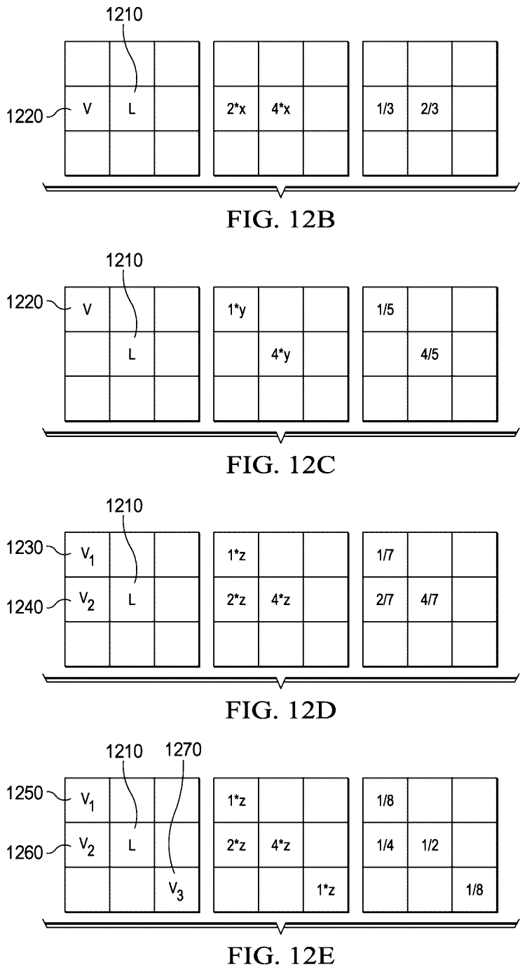

In general, the primary and secondary gains are determined based on a spatial relationship between the listener location L voxel and the neighbor voxel V. In one example, the primary and secondary (or first and second) gains may determined based on a predefined Gaussian kernel centered on the listener location L voxel. FIG. 12A shows examples of Gaussian kernels for 3×3, 5×5, and 7×7 neighborhoods of the listener location L voxel. FIG. 12B and FIG. 12C illustrate how the Gaussian kernel for the 3×3 neighborhood can be used to determine the gains for a case in which the listener location L voxel and the neighbor voxel V are laterally adjacent and diagonally adjacent, respectively. FIG. 12D illustrates an extension in which the Gaussian kernel for the 3×3 neighborhood is used for determining gains for the case of two neighbor voxels. Finally, FIG. 12E illustrates an extension in which the Gaussian kernel for the 3×3 neighborhood is used for determining gains for the case of three neighbor voxels.

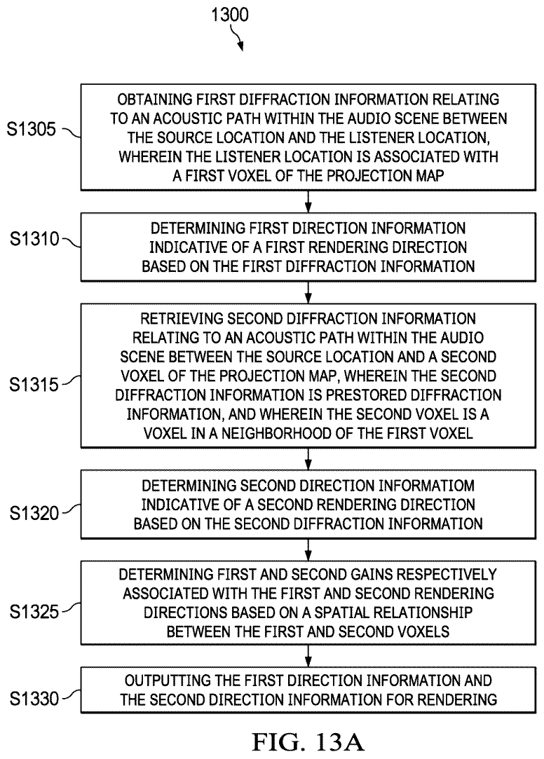

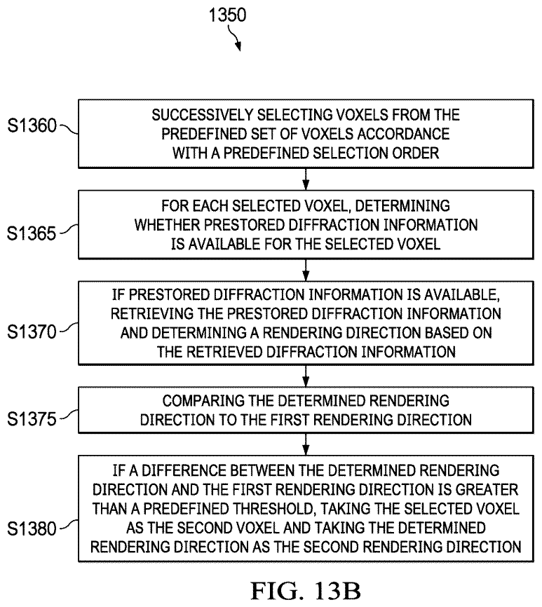

FIG. 13A is a flowchart illustrating an example of a method 1300 of processing audio scene information relating to a voxel-based audio scene represented by a two-dimensional projection map, for providing information for rendering audio from an audio source at a source location in the audio scene to a listener at a listener location in the audio scene, in line with the above. Method 1300 comprises steps S1305 through S1330 that may be performed, for example, upon an update of the source location listener location, or audio scene description.

At step S1305, first diffraction information relating to an acoustic path within the audio scene between the source location and the listener location is obtained. The listener location is associated with (e.g., corresponds to or is included in) a first voxel of the projection map. This first voxel corresponds to the listener location L voxel defined above.

The first diffraction information (and analogously the second diffraction information retrieved in step S1315 below) comprises an indication of a corner voxel (diffraction corner) C_{L} (or C_{V} for the second diffraction information) on the acoustic path for which the diffraction path changes direction and for which the direct line from the first voxel to the corner voxel is not occluded, and may further comprise an indication of a length rₚₐₜₕ of the acoustic path.

The first diffraction information may be obtained by retrieving it from the prestored data, or, if not available, running a pathfinding algorithm. This may be done, for example in accordance with Step 1 or method 600 described above. If a pathfinding algorithm is used for determining the first diffraction information, a representation of the first diffraction information may be output for storage and later reuse, for example as part of the prestored data (e.g., DLUT database). Thereby, the prestored data is successively extended, increasing the likelihood that diffraction information will already be available for future rendering operations.

Whereas the first diffraction information may be determined using a pathfinding algorithm, retrieving the second diffraction information described below does not involve applying any pathfinding algorithm but strictly relies on prestored data.

At step S1310, first direction information indicative of a first rendering direction is determined based on the first diffraction information. The first rendering direction may correspond to (azimuth) angle a_{L} defined in Step 3 above.

At step S1315, second diffraction information relating to an acoustic path within the audio scene between the source location and a second voxel of the projection map is retrieved. Importantly, the second diffraction information is prestored diffraction information. The second voxel is understood to be a voxel in a neighborhood of the first voxel. This neighborhood may be a predefined neighborhood, for example defined by a neighborhood matrix centered on the first voxel. The second voxel may correspond to a voxel determined by successive selection and checking of neighbor voxels V, as described in Step 3 to Step 6 above.

As noted above, retrieving the second diffraction information does not involve applying a pathfinding algorithm.

At step S1320, second direction information indicative of a second rendering direction is determined based on the second diffraction information. The second rendering direction may correspond to the (azimuth) angle a_{V} defined in Step 6 above.

In line with the check performed at Step 6, it is understood that the first and second rendering directions are (sufficiently) different from each other.

At step S1325, which may be optional, first and second gains respectively associated with the first and second rendering directions are determined based on a spatial relationship between the first and second voxels. This may be done for example in line with Step 7 described above. That is, determining the first and second gains may be based on whether the first and second voxels are laterally adjacent or diagonally adjacent in the projection map. Further, the first and second gains may be determined based on a predefined Gaussian kernel (having the same size as the predefined neighborhood of the first voxel), centered at the first voxel.

At step S1330, the first direction information and the second direction information are output for rendering. Further, the first and second gains may be output for rendering at this step. Method 1300 may further comprise a step of selecting the second voxel from the neighborhood of the first voxel according to a predefined selection rule. Details thereof are described in FIG. 13B, which is a flowchart illustrating an example of a method 1350 that relates to an implementation of steps S1315 and S1320 of method 1300. Method 1350 comprises steps S1360 through S1380. The selection of method 1350 may correspond to Step 3 through Step 6 described above.

At step S1360, assuming that the neighborhood of the first voxel is a predefined neighborhood relative to the first voxel and relates to a predefined set of voxels relative to the first voxel, voxels from the predefined set of voxels are successively selected in accordance with a predefined selection order. For example, the selection order defined in Step 3 above may be used.

At step S1365, for each selected voxel, it is determined whether prestored diffraction information is available for the selected voxel. This may correspond to the check at Step 4 above.

At step S1370, if prestored diffraction information is available, the prestored diffraction information is retrieved and a rendering direction based on the retrieved diffraction information is determined. This may correspond to Step 5 above.

At step S1375, the determined rendering direction is compared to the first rendering direction.

At step S1380, if a difference between the determined rendering direction and the first rendering direction is greater than a predefined threshold, the selected voxel is taken as the second voxel and the determined rendering direction is taken as the second rendering direction. Steps S1375 and S1380 may proceed in line with the check at Step 6 above.

If it is found in the steps S1365 to S1380 that the selected voxel is not valid, i.e., does not yield a valid second rendering direction result (e.g., because no prestored diffraction information is available or the check at step S1380 fails), the next voxel in the neighborhood of the first voxel may be selected according to the predefined selection order, and steps S1365 to S1380 are performed for this next voxel, and so forth.

Returning to the proposed algorithm, the algorithm may be concluded by a final step is Step 8.

### Step 8:

Continue the rendering process for the obtained audio diffraction source(s).

### Processing at Scene Initialization or Scene Update

Next, additional processing steps that may be performed at scene initialization and scene update stages will be described.

The subset of voxels (for which the processing of the case (B) should be applied) can be detected at the scene initialization and update stages using the following 3×3 kernel matrix comparison:

$${N}^{( K )} : {[ \begin{matrix}1 & 1 & 1 \\ 1 & 0 & 1 \\ 1 & 1 & 1\end{matrix} ]}_{( x , y )} {if [ \begin{matrix}0 & 0 & 0 \\ 0 & 1 & 0 \\ 0 & 0 & 0\end{matrix} ]}_{( x , y )} == {[ \begin{matrix}{P}_{( x + 1 , y - 1 )} & {P}_{( x + 1 , y + 0 )} & {P}_{( x + 1 , y + 1 )} \\ {P}_{( x + 0 , y - 1 )} & {P}_{( x , y )} & {P}_{( x + 0 , y + 1 )} \\ {P}_{( x - 1 , y - 1 )} & {P}_{( x - 1 , y + 0 )} & {P}_{( x - 1 , y + 1 )}\end{matrix} ]}_{( x , y )}$$

The neighborhood N^{(K)} of the single voxel occluding element K can be determined by evaluating the results of application of the filter kernel to the scene projection map. An example of the neighborhood N^{(K)} is illustrated in FIG. 8.

### Control Parameters for Secondary Diffraction Audio Sources

Next, Control parameters for the “secondary” diffraction audio source(s) will be described.

The present disclosure allows to determine the “secondary” diffraction audio source(s) in a controllable way.
The “secondary” diffraction path generation is controlled by the adjustable parameter h for case (A). The threshold value h determines how much the “secondary” diffraction direction must differ from the “primary” one to be considered for the audio rendering. A suitable fixed setting for the value of h is π/6 (30 degrees), for example.
The “secondary” diffraction path is always calculated and considered for case (B). The difference between the “primary” and “secondary” diffraction directions are always equal to π/2 (90 degrees). Case (B) is considered separately from case (A) because in this case the “secondary” diffraction direction is always essential, and its calculation requires only the knowledge about the “primary” D_{primary}(L) diffraction audio source.

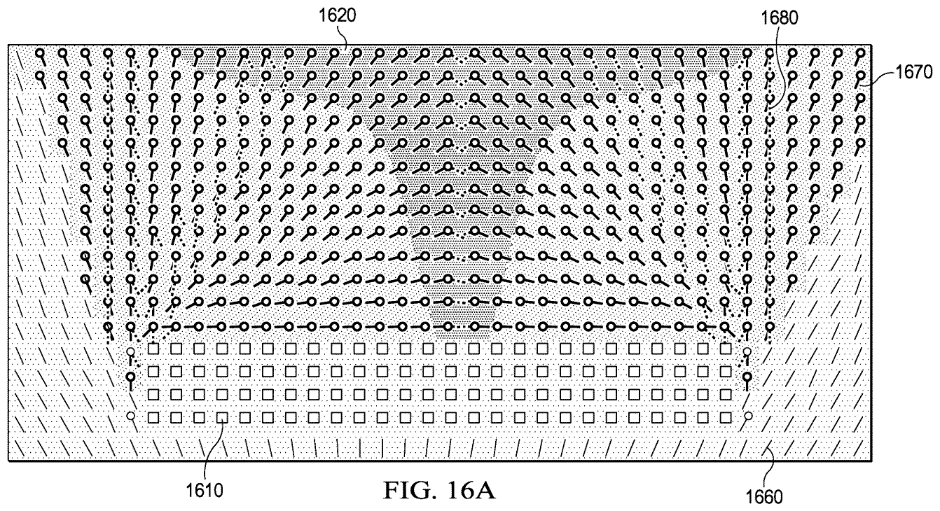

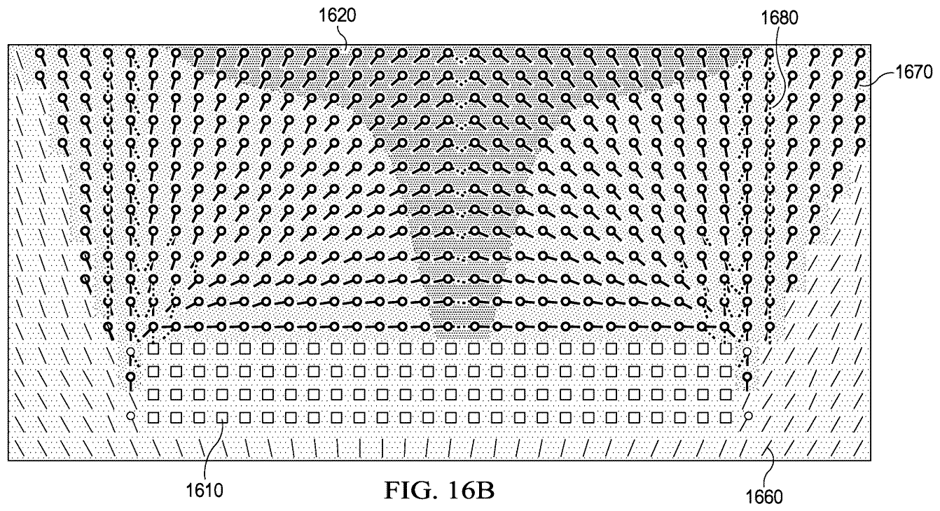

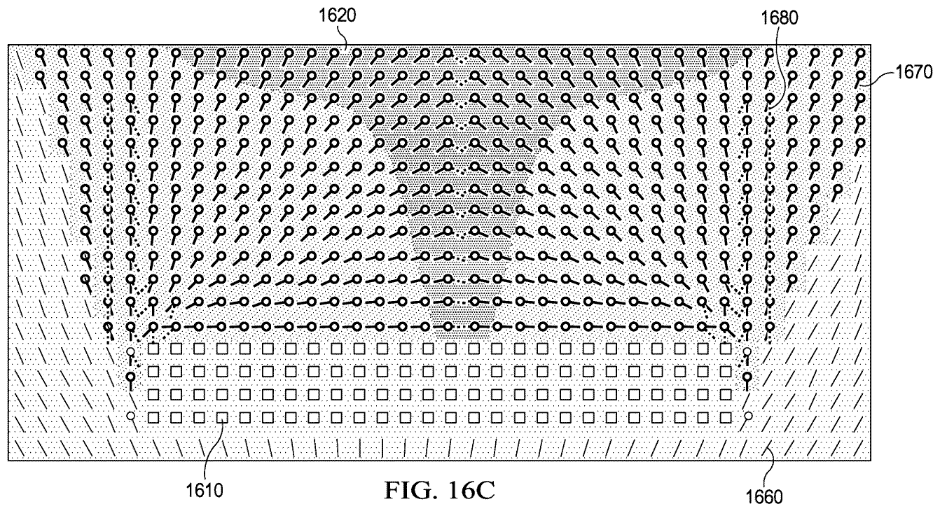

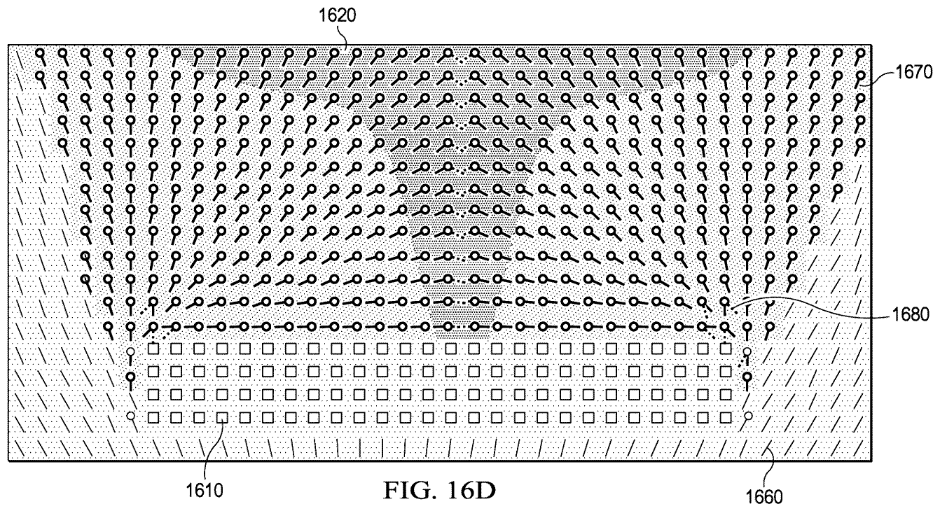

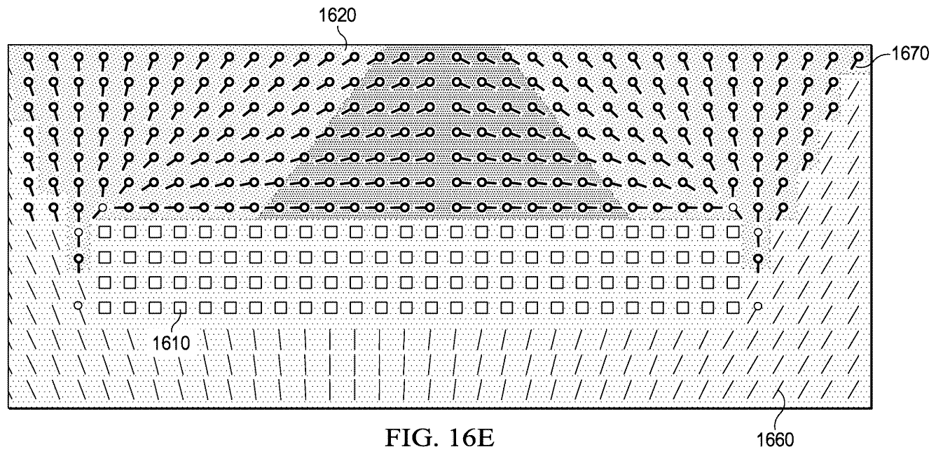

The impact of the threshold value h for the voxel-based audio scene of FIG. 1 is shown in FIG. 16A to FIG. 16E. These figures show a two-dimensional projection map for a voxel-based scene representation. Occluder voxels 1610 are indicated by white squares, with the remaining voxels 1620 (air voxels). Audio directions 1660 towards an un-occluded audio source are indicated by short thin lines 1660, whereas audio diffraction directions 1670 towards a virtual sound source determined by multi-directional diffraction modeling as proposed by the present disclosure are indicated by short thick lines 1670 and short dashed lines 1680. FIG. 16A to FIG. 16E relate to h=0°, h=10°, h=20°, h=30°, and h>180°, respectively.

### Prestored Diffraction Information

The prestored diffraction information may be in the form of DLUT data. Details are described below. However, these details however are not limited to DLUT data but apply to all forms of prestored diffraction information used for purposes of the present disclosure.

DLUT data content

The pre-computed (or cashed) DLUT data contains:
projection map representation (or voxel scene identifier)
start position of the diffraction path (corresponding voxel L indices)
end position of the diffraction path (corresponding voxel O indices)
diffraction corner (i.e., farther voxel C_{L}, visible from the start position L, where the diffraction path changes its direction going around the obstacle)
path length approximation of the total diffracted path trajectory (i.e., path from start to end positions around all occluding elements on the projection map causing the diffraction effect).

An example of detailed bitstream syntax is given in Table 1 and Table 2.

### DLUT Data Sources

The pre-computed (or cashed) DLUT data can be obtained at:
the encoder side (and transmitted in the bitstream), where the content of DLUT data:
   projection map:
      custom definition (e.g., using proprietary projection map creation tools)
   rest of the DLUT data:
      custom definition (e.g., using proprietary pathfinders).
the renderer side (and cashed in the local memory), where the content of DLUT data:
   projection map:
      default, for example using a “slicing cut” method at the scene initialization (or scene update stage)
   rest of the DLUT data:
   the “primary” audio diffraction path computation performed at the audio renderer
      if the user visited the corresponding voxel (needed for the current rendering output)
      if the rendering application triggered the diffraction path computation if computational recourses are available (not needed for the current rendering output).

### Encoder Side DLUT Data Calculations

The straightforward approach to provide the DLUT data to the renderer is to pre-compute audio diffraction paths from all sound source locations to all voxels which a user(s) can visit in the scene. This can be done prior audio rendering at the encoder side. Nevertheless, it is not practical to put every possible diffraction path data into the bitstream, since this direct method results in high computational workload on the encoder and large amount of diffraction modelling related data.

It is more advantageous to pre-compute at the encoder side the diffraction paths only for a subset of all possible user locations (and audio object positions). This subset can be determined semi-automatically and controlled by the content creator (using knowledge of the scene content and envisioned points of user interest). Namely, the encoder application can try to predict the most probable user positions and put only the relevant data to the DLUT payload.

### Renderer Side DLUT Data Calculations

The pre-computed at the renderer side DLUT data has the following advantages:
small bitstream size for the diffraction modelling tool (e.g., empty initial DLUT data)
obtained DLUT data is user relevant and corresponds to voxels actually visited by the user(s) during scene presentation (i.e., regions of the user interest)
DLUT data is continuously amended by the new data during the scene presentation time that improves DLUT scene space coverage, simultaneously improves quality and decreases computational complexity of the audio rendering.

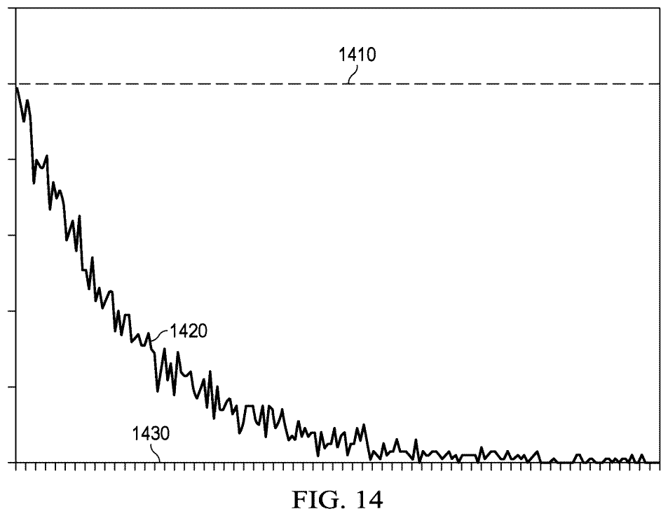

An example of the demands over the scene presentation time is illustrated in FIG. 14, which is a diagram illustrating complexity measures for different implementations of processing audio scene information or audio rendering as functions of time, assuming a simple maze as the audio scene. It is further assumed that the user randomly moves through the maze, thus revisiting previously visited locations. Graph 1410 relates to the case that no pre-computed diffraction information whatsoever is available (e.g., no diffraction information provided with the bitstream, memory/cache disabled). In this case, the computational load on the renderer is substantially constant and comparatively high. Graph 1420 relates to the case that pre-computed diffraction information is locally available (e.g., no diffraction information provided with the bitstream, local memory/cache enabled). In this case, the processing load on the renderer decays over time, since more and more items of diffraction information are locally accumulated. In other words, more and more scene states that are encountered will relate to (locally) known scene states. Graph 1430 finally relates to the case that pre-computed diffraction information is externally provided (e.g., full diffraction information provided with the bitstream). In this case, the computation load on the renderer is constantly low, as a significant portion of scene states relates to known scene states and the diffraction information can be externally retrieved (e.g., from the bitstream or by request from an external/shared storage), without local calculation.

### Combined Approach

The present disclosure suggests applying an optimized combination of these two DLUT data generation approaches (or prestored data generation approaches in general). Namely, the content-creator may define some pre-designed DLUT data entries into the bitstream (using the scene knowledge and intentions for the users' behavior), see FIG. 11. Additional DLUT data is continuously computed and added by the running audio renderer(s) (according to listener's movements and interactions with the scene) during the scene presentation time, for example in accordance with Step 1 or method 600 described above.

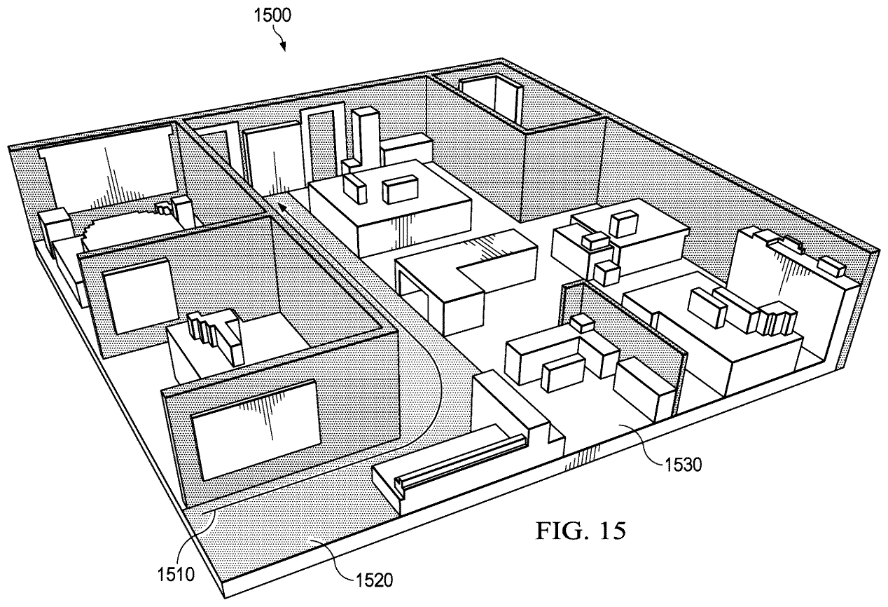

FIG. 15 illustrates an example of an environment with the sub-space 1520 associated with the encoder pre-computed DLUT data and a content-creator expected user movement path 1510 for scene geometry elements represented by the projection map. For remaining sub-space 1530, no pre-designed LUT data entries are provided in the bitstream and additional DLUT data is continuously computed by the renderer and added to the DLUT data during the scene presentation time.

The (prestored) diffraction information (e.g., DLUT data) may be stored as part of a voxSceneDiffractionPreComputedPathData( ) syntax element according to ISO/IEC 23090-4 (Coded representation of immersive media—Part 4: MPEG-I immersive audio, https://www.iso.org/standard/84711.html), or according to any future standard deriving therefrom. The voxSceneDiffractionPreComputedPathData( ) syntax element according to the MPEG-I standard is shown in Table 2.

TABLE 2
Syntax of voxSceneDiffractionPreComputedPathData( )

| | No. of | |
|---|---|---|
| Syntax | bits | Mnemonic |
| voxSceneDiffractionPreComputedPathData( ) | | |
| { | | |
| numberOfVoxDiffractionPathData = | | |
| escapedValue(8, 16, | | |
| 32) | | |
| for (int i = 0; i < | | |
| numberOfVoxDiffractionPathData; i ++) | | |
| { | | |
| voxDiffractionPathStartVoxelPacked[i]; | NbitsMap | uimsbf |
| voxDiffractionPathEndVoxelPacked [i]; | NbitsMap | uimsbf |
| voxDiffractionPathDataExistFlag[i]; | 1 | bslbf |
| if (voxDiffractionPathDataExistFlag[i] == | | |
| 1) { | | |
| | Nbits Map | uimsbf |
| voxDiffractionSourceDirectionPacked[i]; | | |
| voxDiffractionPathLength[i][j]; | 32 | float |
| } | | |
| } | | |
| } | | |

Note:
NbitsMap = ceil(log2(voxSceneDimensions[0]*voxSceneDimensions[1] − 1)

voxSceneDiffractionPreComputedPathData( ) is a bitstream syntax that parses the bitstream and retrieves the precomputed (stored) diffraction information. This voxel payload data structure may have the following elements:

| | |
|---|---|
| numberOfVoxDiffractionPathData | This element represents the number of pre-computed |
| | diffraction path data sets. |
| voxDiffractionPathStartVoxelPacked | This element represents the packed form of the variable |
| | voxDiffractionPathStartVoxel indicating the voxel |
| | indices of the path start voxel of the pre-computed |
| | diffraction path. |
| voxDiffractionPathEndVoxelPacked | This element represents the packed form of the variable |
| | voxDiffractionPathEndVoxel indicating the voxel indices |
| | of the path end voxel of the pre-computed diffraction path. |
| voxDiffractionPathDataExistFlag | This element indicates whether the diffraction path exists |
| | or not. |
| voxDiffractionSourceDirectionPacked | This element represents the packed form of the variable |
| | voxDiffractionSourceDirection indicating the voxel |
| | indices of the voxel for determining diffracted source |
| | azimuth value. |
| voxDiffractionPathLength | This element represents the diffraction path length on the |
| | diffraction map 2D matrix. |
| voxSceneDimensions | The number of voxels per each scene dimension. |
| escapedValue( ) | This element implements a general method to transmit an |
| | integer value using a varying number of bits. It features a |
| | two level escape mechanism which allows to extend the |
| | representable range of values by successive transmission |
| | of additional bits. Syntax of escapedValue( ) shall be as |
| | defined in ISO/IEC 23003-3. |

Thus, an additional technical benefit and effect according to techniques of the present disclosure is that the scene state identifier or other information derived from the scene state (scene description together with source location) may be used to avoid application of the diffraction modeling tools or rendering tools if the corresponding processing was already done for this scene state and the diffraction information or 3DoF auralizer data are available. In this scenario the renderer can access the diffraction information/3DoF auralizer data (for a known scene state) without application of the rendering tools by re-using the data calculated before (precomputed) or at scene presentation time.

### Apparatus for Implementing Methods According to the Disclosure

While methods and processing chains have been described above, it is understood that the present disclosure likewise relates to apparatus (e.g., computer apparatus or apparatus having processing capability in general) for implementing these methods and processing chains (or techniques in general).

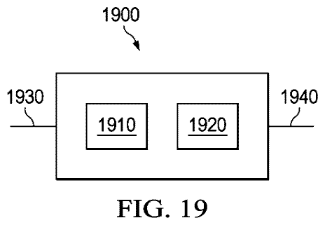

An example of such apparatus 1900 is schematically illustrated in FIG. 19. The apparatus 1900 comprises a processor 1901 and a memory 1902 coupled to the processor 1901. The memory 1902 may store instructions for execution by the processor 1901. The processor 1901 may be adapted to implement the processing chains described throughout the disclosure and/or to perform methods (e.g., methods of processing audio scene information for audio rendering, such as method 600 of FIG. 6, method 700 of FIG. 7, and/or methods 1300, 1350 of FIGS. 13A, 13B) described throughout the disclosure. The apparatus 1900 may receive inputs 1930 (e.g., audio scene description, listener location, etc.) and generate outputs 1940 (e.g., direction information, gains, etc.).

### Simulation Results

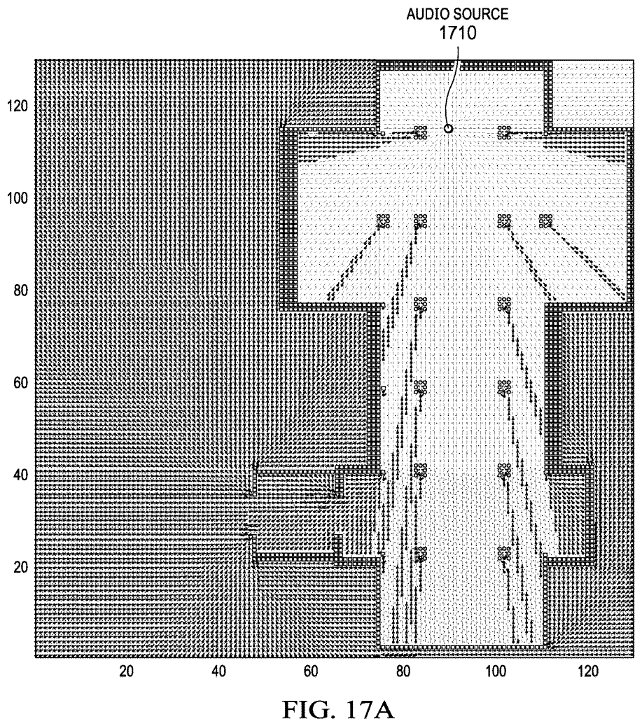

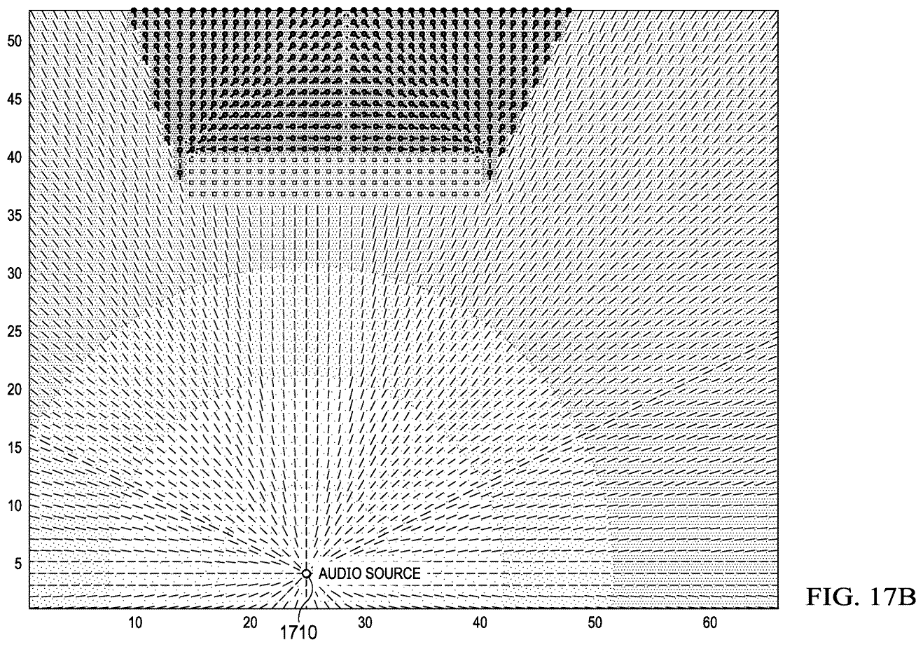

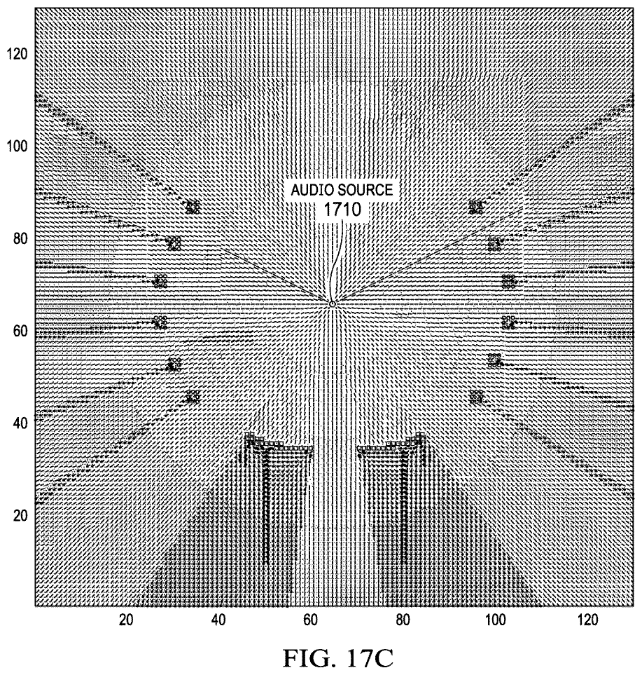

FIG. 17A to FIG. 17C show examples of multipath diffraction directions for an audio source 1710 in different audio scenes when using multi-directional audio diffraction modeling according to embodiments of the disclosure.

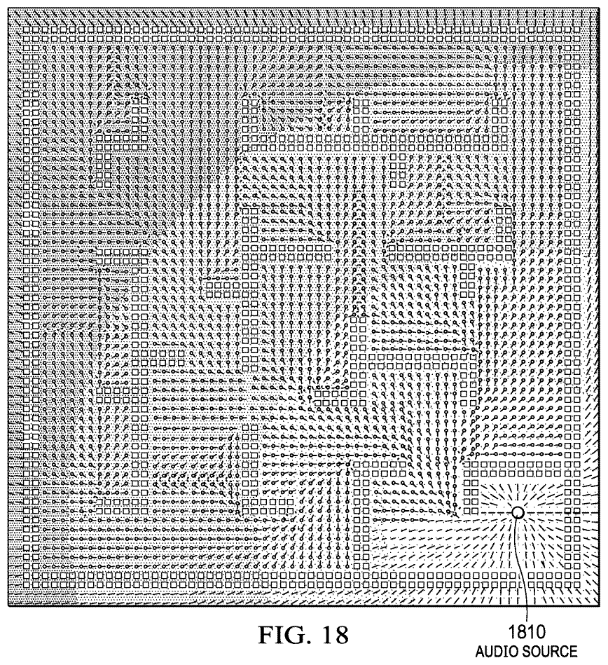

FIG. 18 illustrates an example of multipath diffraction directions for an audio source 1810 in a simple maze test scene when using multi-directional audio diffraction modeling according to embodiments of the disclosure.

### Interpretation

Aspects of the systems described herein may be implemented in an appropriate computer-based sound processing network environment (e.g., server or cloud environment) for processing digital or digitized audio files. Portions of these systems may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, computer-implemented neural networks described herein can include one or more electronic processors, one or more computer-readable medium modules, one or more input/output interfaces, and various connections (e.g., a system bus) connecting the various components.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### ENUMERATED EXAMPLE EMBODIMENTS

Various Aspects and implementations of the invention may also be appreciated from the following enumerated example embodiments (EEEs), which are not claims.
EEE1. A method of processing audio scene information relating to a voxel-based audio scene represented by a two-dimensional projection map, for rendering audio from an audio source at a source location in the audio scene to a listener at a listener location in the audio scene, the method comprising:
obtaining first diffraction information relating to an acoustic path within the audio scene between the source location and the listener location, wherein the listener location is associated with a first voxel of the projection map;
determining first direction information indicative of a first rendering direction based on the first diffraction information;
retrieving second diffraction information relating to an acoustic path within the audio scene between the source location and a second voxel of the projection map, wherein the second diffraction information is prestored diffraction information, and wherein the second voxel is a voxel in a neighborhood of the first voxel;
determining second direction information indicative of a second rendering direction based on the second diffraction information; and
outputting the first direction information and the second direction information for rendering.
EEE2. The method according to EEE1, further comprising selecting the second voxel from the neighborhood of the first voxel according to a predefined selection rule.
EEE3. The method according to EEE2, wherein the neighborhood of the first voxel is a predefined neighborhood relative to the first voxel, relating to a predefined set of voxels relative to the first voxel; and
selecting the second voxel comprises:
successively selecting voxels from the predefined set of voxels in accordance with a predefined selection order.
EEE4. The method according to EEE3, wherein selecting the second voxel further comprises: for each selected voxel, determining whether prestored diffraction information is available for the selected voxel;
if prestored diffraction information is available, retrieving the prestored diffraction information and determining a rendering direction based on the retrieved diffraction information.
EEE5. The method according to EEE4, wherein selecting the second voxel further comprises: comparing the determined rendering direction to the first rendering direction; and if a difference between the determined rendering direction and the first rendering direction is greater than a predefined threshold, taking the selected voxel as the second voxel and taking the determined rendering direction as the second rendering direction.
EEE6. The method according to any one of EEE1 to EEE5, further comprising determining first and second gains respectively associated with the first and second rendering directions based on a spatial relationship between the first and second voxels.
EEE7. The method according to EEE6, wherein determining the first and second gains is based on whether the first and second voxels are laterally adjacent or diagonally adjacent in the projection map.
EEE8. The method according to EEE6 or EEE7, wherein the first and second gains are determined based on a predefined Gaussian kernel.
EEE9. The method according to any one of EEE1 to EEE8, comprising:
determining whether the first voxel is adjacent to an isolated occluder voxel of the projection map; and if the first voxel is adjacent to the isolated occluder voxel, determining second direction information indicative of a second rendering direction based on the first rendering direction and a spatial relationship between the first voxel and the occluder voxel.
EEE10. The method according to any one of EEE1 to EEE9, wherein obtaining the first diffraction information involves applying a pathfinding algorithm.
EEE11. The method according to any one of EEE1 to EEE10, further comprising outputting a representation of the first diffraction information for storage.
EEE12. The method according to any one of EEE1 to EEE11, wherein the diffraction information comprises an indication of a corner voxel on the acoustic path for which the diffraction path changes direction and for which the direct line from the first voxel to the corner voxel is not occluded.
EEE13. The method according to EEE12, wherein the diffraction information further comprises an indication of a length of the acoustic path.
EEE14. A method of processing audio scene information relating to a voxel-based audio scene represented by a two-dimensional projection map, for rendering audio from an audio source at a source location in the audio scene to a listener at a listener location in the audio scene, the method comprising:
determining whether a first voxel of the projection map associated with the listener location is adjacent to an isolated occluder voxel of the projection map;
if the first voxel is adjacent to the isolated occluder voxel, obtaining first diffraction information relating to an acoustic path within the audio scene between the source location and the listener location;
determining first direction information indicative of a first rendering direction based on the first diffraction information; and
determining second direction information indicative of a second rendering direction based on the first rendering direction and a spatial relationship between the first voxel and the occluder voxel.
EEE15. The method according to EEE14, wherein the second rendering direction is determined by rotation of the first rendering direction by 90 degrees.
EEE16. The method according to EEE15, wherein a direction of rotation for rotating the first rendering direction is determined based on the first rendering direction and a direction pointing from the first voxel to the occluder voxel.
EEE17. The method according to EEE15 or EEE16, wherein the second rendering direction is determined so that a direction pointing from the first voxel to the occluder voxel is within a sector spanned by the first and second rendering directions.
EEE18. The method according to any one of EEE14 to EEE17, wherein determining whether the first voxel is adjacent to the isolated occluder voxel comprises comparing the first voxel to a predefined set of voxels that are indicated as adjacent to an isolated occluder voxel.
EEE19. A method of processing audio scene information relating to a voxel-based audio scene represented by a two-dimensional projection map, for rendering audio from an audio source at a source location in the audio scene to a listener at a listener location in the audio scene, the method comprising:
determining pathfinding-based diffraction information relating to an acoustic path within the audio scene between the source location and the listener location by applying a pathfinding algorithm, wherein the listener location is associated with a first voxel of the projection map, and wherein the pathfinding-based diffraction information comprises an indication of a corner voxel on the acoustic path for which the diffraction path changes direction and for which the direct line from the first voxel to the corner voxel is not occluded;
identifying a set of voxels that are intersected by a portion of the acoustic path extending between the first voxel and the corner voxel;
determining derived diffraction information for each voxel of the identified set of voxels based on the pathfinding-based diffraction information; and
outputting the pathfinding-based diffraction information and the derived diffraction information for storage.
EEE20. The method according to EEE19, wherein the derived diffraction information for each voxel of the identified set of voxels is indicative of the same corner voxel as the pathfinding-based diffraction information.
EEE21. The method according to EEE20, wherein the pathfinding-based diffraction information further comprises an indication of a length of the acoustic path; and determining the derived diffraction information for a given voxel of the identified set of voxels comprises determining a derived length of the acoustic path based on the length of the acoustic path and a distance between the first voxel and the given voxel.
EEE22. An apparatus comprising a processor and a memory coupled to the processor, and storing instructions for the processor, wherein the processor is adapted to carry out the method according to any one of EEE1 to EEE21.
EEE23. A program comprising instructions that, when executed by a processor, cause the processor to carry out the method according to any one of EEE1 to EEE21.
EEE24. A computer-readable storage medium storing the program of EEE23.

1. A method of processing audio scene information relating to a voxel-based audio scene represented by a two-dimensional projection map, for rendering audio from an audio source at a source location in the audio scene to a listener at a listener location in the audio scene, the method comprising:
obtaining first diffraction information relating to an acoustic path within the audio scene between the source location and the listener location, wherein the listener location is associated with a first voxel of the projection map;
determining first direction information indicative of a first rendering direction based on the first diffraction information;
retrieving second diffraction information relating to an acoustic path within the audio scene between the source location and a second voxel of the projection map, wherein the second diffraction information is prestored diffraction information, and wherein the second voxel is a voxel in a neighborhood of the first voxel;
determining second direction information indicative of a second rendering direction based on the second diffraction information; and
outputting the first direction information and the second direction information for rendering.

2. The method according to claim 1, further comprising selecting the second voxel from the neighborhood of the first voxel according to a predefined selection rule.

3. The method according to claim 2, wherein the neighborhood of the first voxel is a predefined neighborhood relative to the first voxel, relating to a predefined set of voxels relative to the first voxel; and
selecting the second voxel comprises:
successively selecting voxels from the predefined set of voxels in accordance with a predefined selection order.

4. The method according to claim 3, wherein selecting the second voxel further comprises:
for each selected voxel, determining whether prestored diffraction information is available for the selected voxel;
if prestored diffraction information is available, retrieving the prestored diffraction information and determining a rendering direction based on the retrieved diffraction information.

5. The method according to claim 4, wherein selecting the second voxel further comprises:
comparing the determined rendering direction to the first rendering direction; and
if a difference between the determined rendering direction and the first rendering direction is greater than a predefined threshold, taking the selected voxel as the second voxel and taking the determined rendering direction as the second rendering direction.

6. The method according to claim 1, further comprising determining first and second gains respectively associated with the first and second rendering directions based on a spatial relationship between the first and second voxels.

7. The method according to claim 6, wherein determining the first and second gains is based on whether the first and second voxels are laterally adjacent or diagonally adjacent in the projection map.

8. The method according to claim 6, wherein the first and second gains are determined based on a predefined Gaussian kernel.

9. The method according to claim 1, comprising:
determining whether the first voxel is adjacent to an isolated occluder voxel of the projection map; and
if the first voxel is adjacent to the isolated occluder voxel, determining second direction information indicative of a second rendering direction based on the first rendering direction and a spatial relationship between the first voxel and the occluder voxel.

10. The method according to claim 1, wherein obtaining the first diffraction information involves applying a pathfinding algorithm.

11. The method according to claim 1, further comprising outputting a representation of the first diffraction information for storage.

12. The method according to claim 1, wherein the diffraction information comprises an indication of a corner voxel on the acoustic path for which the diffraction path changes direction and for which the direct line from the first voxel to the corner voxel is not occluded.

13. The method according to claim 12, wherein the diffraction information further comprises an indication of a length of the acoustic path.

14. A method of processing audio scene information relating to a voxel-based audio scene represented by a two-dimensional projection map, for rendering audio from an audio source at a source location in the audio scene to a listener at a listener location in the audio scene, the method comprising:
determining whether a first voxel of the projection map associated with the listener location is adjacent to an isolated occluder voxel of the projection map;
if the first voxel is adjacent to the isolated occluder voxel, obtaining first diffraction information relating to an acoustic path within the audio scene between the source location and the listener location;
determining first direction information indicative of a first rendering direction based on the first diffraction information; and
determining second direction information indicative of a second rendering direction based on the first rendering direction and a spatial relationship between the first voxel and the occluder voxel.

15. The method according to claim 14, wherein the second rendering direction is determined by rotation of the first rendering direction by 90 degrees.

16. The method according to claim 15, wherein a direction of rotation for rotating the first rendering direction is determined based on the first rendering direction and a direction pointing from the first voxel to the occluder voxel.

17. The method according to claim 15, wherein the second rendering direction is determined so that a direction pointing from the first voxel to the occluder voxel is within a sector spanned by the first and second rendering directions.

18. The method according to claim 14, wherein determining whether the first voxel is adjacent to the isolated occluder voxel comprises comparing the first voxel to a predefined set of voxels that are indicated as adjacent to an isolated occluder voxel.

19. A method of processing audio scene information relating to a voxel-based audio scene represented by a two-dimensional projection map, for rendering audio from an audio source at a source location in the audio scene to a listener at a listener location in the audio scene, the method comprising:
determining pathfinding-based diffraction information relating to an acoustic path within the audio scene between the source location and the listener location by applying a pathfinding algorithm, wherein the listener location is associated with a first voxel of the projection map, and wherein the pathfinding-based diffraction information comprises an indication of a corner voxel on the acoustic path for which the diffraction path changes direction and for which the direct line from the first voxel to the corner voxel is not occluded;
identifying a set of voxels that are intersected by a portion of the acoustic path extending between the first voxel and the corner voxel;
determining derived diffraction information for each voxel of the identified set of voxels based on the pathfinding-based diffraction information; and
outputting the pathfinding-based diffraction information and the derived diffraction information for storage.

20. The method according to claim 19, wherein the derived diffraction information for each voxel of the identified set of voxels is indicative of the same corner voxel as the pathfinding-based diffraction information.

21. The method according to claim 20, wherein the pathfinding-based diffraction information further comprises an indication of a length of the acoustic path; and
determining the derived diffraction information for a given voxel of the identified set of voxels comprises determining a derived length of the acoustic path based on the length of the acoustic path and a distance between the first voxel and the given voxel.

22. An apparatus comprising a processor and a memory coupled to the processor, and storing non-transitory instructions for the processor, wherein the processor is adapted to carry out the method according to claim 1.

23. A non-transitory program comprising instructions that, when executed by a processor, cause the processor to carry out the method according to claim 1.

24. A non-transitory computer-readable storage medium storing the program of claim 23.
